(19) United States
(12) Patent Application Publication
(10) Pub. No.: US 2012/0182512 A1
(43) Pub. Date: Jul. 19, 2012

(54) LIQUID CRYSTAL DISPLAY DEVICE

(76) Inventors: Takehisa Sakurai, Osaka-shi (JP); Shoichi Ishihara, Osaka-shi (JP); Shuichi Kozaki, Osaka-shi (JP); Mitsuhiro Murata, Osaka-shi (JP); Tadashi Ohtake, Osaka-shi (JP)

(21) Appl. No.: 13/389,119

(22) PCT Filed: Mar. 9, 2010
(86) PCT No.: PCT/JP2010/053870

§ 371 Date: Mar. 29, 2012

(30) Foreign Application Priority Data
Aug. 7, 2009 (JP) 2009-184818

(51) Int. Cl. G02F 1/1343

(52) U.S. Cl. 349/141

(57) ABSTRACT

This invention provides a liquid crystal display device in which response characteristics of liquid crystal molecules are improved. The liquid crystal display device includes a pair of substrates that are disposed facing each other, and a liquid crystal layer that is sandwiched between the pair of substrates. The liquid crystal layer contains liquid crystal molecules having positive dielectric anisotropy. The liquid crystal molecules align in a vertical direction relative to surfaces of the pair of substrates in a state in which a voltage is not applied thereto. The pair of substrates includes two or more sets of comb-shaped electrode pairs in which comb tooth portions of each comb-shaped electrode are alternately disposed with each other with a certain space therebetween. One substrate of the pair of substrates comprises a first polarizer. The other substrate of the pair of substrates comprises a second polarizer. A long axis of a comb tooth portion of a first comb-shaped electrode pair among the two or more sets of comb-shaped electrode pairs and a transmission axis of the first polarizer form an angle of substantially 45°. A long axis of a comb tooth portion of a second comb-shaped electrode pair among the two or more sets of comb-shaped electrode pairs and a transmission axis of the second polarizer are in a parallel or orthogonal relationship with each other. The transmission axis of the first polarizer and the transmission axis of the second polarizer are orthogonal to each other. The first comb-shaped electrode pair and the second comb-shaped electrode pair overlap with each other when the surfaces of the pair of substrates are viewed from a normal line direction.

### TECHNICAL FIELD

The present invention relates to a liquid crystal display device. More specifically, the present invention relates to a liquid crystal display device that adopts a mode in which the initial alignment of liquid crystal molecules is a vertical alignment, and which generates a transverse electric field to perform control of the liquid crystal molecules.

### BACKGROUND ART

Liquid crystal display devices are characterized by being thin and light, and having low power consumption, and are widely used in various fields. The display performance of liquid crystal display devices has been remarkably improved over the years, and is now becoming superior to that of a CRT (cathode ray tube).

The display system of a liquid crystal display device is defined by the manner in which liquid crystals are aligned in cells. Various display systems such as a TN (twisted nematic) mode, an MVA (multi-domain vertical alignment) mode, an IPS (in-plane switching) mode, and an OCB (optically self-compensated birefringence) mode are already known as display systems of liquid crystal display devices.

Among these, the IPS mode is a system that controls the molecular alignment state of nematic liquid crystals by disposing a comb-shaped electrode pair on a substrate, arranging comb tooth portions of the comb-shaped electrode pair in a staggered configuration, and forming an electric field in a horizontal direction to the substrate between the comb tooth portions (for example, see Patent Literature 1 to 4). More particularly, according to the IPS mode, a light blocking state and a light transmitting state are controlled by providing a polarizer and forcefully changing the molecular alignment state of nematic liquid crystals to a vertical direction or a horizontal direction relative to a substrate by switching the direction of an applied electric field in accordance with an input signal. The IPS mode can obtain response speeds that are close to 100 times faster than response speeds in the TN mode. In the respective disclosures of the above described Patent Literature, various forms of arranging comb-shaped electrodes to improve characteristics in the IPS mode are described.

In general, liquid crystal display devices, and not just liquid crystal display devices that adopt the IPS mode, have various circuits for performing image display (for example, see Patent Literature 5). For example, an image signal processing circuit that converts information that is supplied from outside into signals that a liquid crystal display panel can display, a data line drive circuit for supplying an image signal to a pixel array, and a gate line drive circuit that supplies a control signal so as to select one gate line for each pixel array to display an image on a liquid crystal display panel for a period of time during one frame period are provided in a liquid crystal display device.
[Patent Literature 1] Japanese Patent Laid-Open No. H-01-120528
[Patent Literature 2] Japanese Patent Laid-Open No. H-07-134301
[Patent Literature 3] Japanese Patent Laid-Open No. H-07-318959
[Patent Literature 4] Japanese Patent Laid-Open No. 2008-164958
[Patent Literature 5] Japanese Patent Laid-Open No. H-11-109921

### DISCLOSURE OF THE INVENTION

Regarding the above described IPS mode, recently, a display system has been proposed that adopts a mode that, using nematic liquid crystals having positive dielectric anisotropy as a liquid crystal material, controls the alignment of liquid crystal molecules by generating a transverse electric field using a pair of electrodes that include comb teeth, while vertically aligning the nematic liquid crystals and maintaining a high contrast characteristic.

According to the aforementioned mode, liquid crystal molecules are aligned in a bent shape in the transverse direction, the director distribution forms an arch shape along the transverse electric field, and there are complementary alignment characteristics between two adjacent electrodes. Hence, even when viewing the display surface from an oblique direction, the display surface can be viewed with a display quality that is the same as when viewing the display surface from the front direction. Accordingly, the problem whereby, for example, as in the VA mode, the birefringence state of light differs between the front direction and an oblique direction because liquid crystal molecules are a rod-like shape and consequently the voltage-transmittance characteristics (V-T characteristics) change depending on the viewing angle is solved.

FIG. 31 is a perspective schematic view illustrating the configuration of a liquid crystal display device of a type that generates a transverse electric field using a pair of electrodes that include comb teeth with respect to a liquid crystal layer including nematic liquid crystals having positive dielectric anisotropy in which the initial alignment of the liquid crystals is a vertical alignment. As shown in FIG. 31, a liquid crystal display element of the above described mode has a pair of substrates 110 and 120, and a liquid crystal layer 104 is sealed between the pair of substrates 110 and 120. The pair of substrates 110 and 120 includes a transparent substrate 151 and 161, respectively, as a main constituent and have a vertical alignment layer 152 and 162, respectively, on a surface on a side that contacts the liquid crystal layer 104 side. Therefore, while a voltage is not applied to the liquid crystal layer 104, all of liquid crystal molecules 103 exhibit a vertical alignment (homeotropic alignment). Application of a voltage to the liquid crystal layer 104 can be performed by means of a pair of comb-shaped electrodes 121 and 122 formed in one of the substrates among the pair of substrates 110 and 120. Transmission or blocking of light is selected by means of polarizers 101 and 102 that are disposed on a surface on a side opposite to the liquid crystal layer of the transparent substrates 151 and 161, respectively.

According to this basic configuration, a bent electric field is formed by application of an electric field, and since two domains in which the director orientations are symmetric to each other are formed in a region between the pair of electrodes in the liquid crystal layer, a wide viewing angle characteristic can be obtained.

FIG. 32 is a schematic diagram that illustrates equipotential curves in a cell when a voltage of 7V is applied thereto. As shown in FIG. 32, when a voltage equal to or greater than a threshold value is applied, the liquid crystal molecules align under the influence of a constraining force from a field intensity distribution and a boundary surface.

However, as a result of conducting studies in further detail regarding response speeds, the applicants of the present application found that although a change (fall) in which liquid crystal molecules align in the vertical direction from the horizontal direction relative to a substrate surface is fast, a change (rise) in which liquid crystal molecules align in the horizontal direction from the vertical direction relative to a substrate surface can not be considered to be fast, and therefore the response characteristics with respect to a response from a state in which the voltage is off to a state in which the voltage is turned on are low in comparison to response characteristics with respect to a response from a state in which the voltage is on to a state in which the voltage is turned off.

FIG. 33 is a graph that illustrates rise response characteristics and fall response characteristics of a liquid crystal display device of a type that generates a transverse electric field using a pair of electrodes that have comb teeth with respect to a liquid crystal layer including nematic liquid crystals having positive dielectric anisotropy in which the initial alignment of the liquid crystals is a vertical alignment. As shown in FIG. 33, according to the liquid crystal display device of the aforementioned mode, on the one hand fast response characteristics are obtained at any voltage with respect to the fall characteristics (response characteristics from a state in which the voltage is on to a state in which the voltage is turned off) that are represented by the symbol “x” in FIG. 33, on the other hand, although the rise characteristics (response characteristics from a state in which the voltage is off to a state in which the voltage is turned on) that are represented by the symbol “o” in FIG. 33 become faster as the voltage increases, it can not be said that fast response characteristics are obtained with respect to the rise characteristics at relatively low voltages. Therefore, with respect to the overall response characteristics of the device that are represented by the symbol “▪” in FIG. 33, because of the influence of the rise characteristics, it can not be said that sufficiently fast response characteristics are obtained at all voltages.

The present invention has been conceived in view of the above described circumstances, and an object of the present invention is to provide a liquid crystal display device in which the response characteristics of liquid crystal molecules are improved.

The applicants of the present application performed various studies regarding methods to improve the response characteristics of liquid crystal molecules, and focused on the electrode structure of the liquid crystal display device according to the above described mode. As a result, the applicants of the present application found that the liquid crystal display device according to the above described mode that is currently proposed controls the alignment of liquid crystal molecules by means of comb-shaped electrodes that form a pair per picture element, and conceived of providing an additional pair of comb-shaped electrodes to enable control of the alignment properties of liquid crystal molecules using the additional pair of comb-shaped electrodes also. Furthermore, the applicants of the present application found that by adjusting the arrangement relationship between the transmission axis of a polarizer and the long axis of a comb-shaped electrode pair, transmittance of light and blocking of light by the polarizer can be controlled utilizing a fact that a response from a state in which a display is on to a state in which the display is off is a change (rise) in which liquid crystal molecules align in a horizontal direction from a vertical direction when a high voltage is applied thereto, and conceived of enabling a fast response to be obtained with respect to both a response from an off state to an on state and a response from an on state to an off state of a display.

More specifically, the applicants of the present application found that, for one of the comb-shaped electrode combinations, by adjusting so that a long axis of a comb tooth portion of the comb-shaped electrodes and a transmission axis of one polarizer form an angle of substantially 45°, and for the other of the comb-shaped electrode combinations, by adjusting so that a long axis of a comb tooth portion of the comb-shaped electrodes and a transmission axis of another polarizer are parallel or orthogonal, and furthermore, by disposing the respective comb-shaped electrode combinations so as to overlap with each other when viewing the aforementioned pair of substrate surfaces from a normal line direction, for example, when the aforementioned one of the comb-shaped electrode combinations is used to apply a voltage to form a transverse electric field and generate an angle between the alignment orientation of the liquid crystal molecules and the transmission axis orientation of the polarizer, a state is entered in which light can pass through the polarizer. Further, on the other hand, when the aforementioned other of the comb-shaped electrode combinations is used to apply a voltage to form a transverse electric field to make the alignment orientation of the liquid crystal molecules and the transmission axis orientation of the polarizer orthogonal or parallel, a state is entered in which light is blocked by the polarizer. Thus, the applicants of the present application found that, with respect to turning the display off, control can be performed with fast rise characteristics by applying a high voltage in a direction that makes the alignment orientation of liquid crystal molecules parallel or vertical relative to the axis of a polarizer, and with respect to turning the display on, control can be performed by means of the fall characteristics of the liquid crystal molecules.

Thus, the applicants of the present application successfully solved the above described problem, and accomplished the present invention.

More specifically, according to the present invention there is provided a liquid crystal display device including a pair of substrates that are disposed facing each other, and a liquid crystal layer that is sandwiched between the pair of substrates, wherein: the liquid crystal layer contains liquid crystal molecules having positive dielectric anisotropy; the liquid crystal molecules align in a vertical direction relative to surfaces of the pair of substrates in a state in which a voltage is not applied thereto; the pair of substrates includes two or more sets of comb-shaped electrode pairs in which comb tooth portions of each comb-shaped electrode are alternately disposed with each other with a certain space therebetween; one substrate of the pair of substrates comprises a first polarizer; another substrate of the pair of substrates comprises a second polarizer; a long axis of a comb tooth portion of a first comb-shaped electrode pair among the two or more sets of comb-shaped electrode pairs and a transmission axis of the first polarizer form an angle of substantially 45′; a long axis of a comb tooth portion of a second comb-shaped electrode pair among the two or more sets of comb-shaped electrode pairs and a transmission axis of the second polarizer are in a parallel or orthogonal relationship with each other; the transmission axis of the first polarizer and the transmission axis of the second polarizer are orthogonal to each other; and the first comb-shaped electrode pair and the second comb-shaped electrode pair overlap with each other when the surfaces of the pair of substrates are viewed from a normal line direction.

Hereunder, the liquid crystal display device of the present invention is described in detail.

The liquid crystal display device of the present invention includes a pair of substrates that are disposed facing each other, and a liquid crystal layer that is sandwiched between the pair of substrates. Liquid crystal molecules whose alignment properties are controlled by application of a certain voltage are filled in the liquid crystal layer. By providing wiring, an electrode, a semiconductor device and the like on one or both of the pair of substrates, it is possible to apply a voltage into the liquid crystal layer and control the alignment properties of the liquid crystal molecules.

The liquid crystal layer contains liquid crystal molecules that have positive dielectric anisotropy. Consequently, when a voltage is applied into the liquid crystal layer, the liquid crystal molecules align along the direction of an electric field, and as a result, a group of liquid crystal molecules form an arch shape.

The liquid crystal molecules align in a vertical direction relative to surfaces of the pair of substrates in a state in which a voltage is not applied thereto. By regulating the initial alignment of the liquid crystal molecules in this manner, blocking of light at the time of a black display can be performed effectively. As a method of vertically aligning liquid crystal molecules in a state in which a voltage is not applied thereto, for example, a method in which a vertical alignment layer is disposed on a surface that contacts with the liquid crystal layer of one or both of the pair of substrates may be mentioned. As used herein, the term “vertical” includes not only a completely vertical state, but also a substantially vertical state. In this case, the term “vertical” preferably refers to an angle within a range of 90±2°.

The pair of substrates includes two or more sets of comb-shaped electrode pairs in which comb tooth portions of each comb-shaped electrode are alternately disposed with each other with a certain space therebetween. The term “comb tooth portion” of the comb-shaped electrodes refers to linear parts that are formed so as to protrude planarly from a part that serves as a trunk portion. An electric field that arises when a potential difference is applied between a pair of electrodes having such kind of comb tooth portions is an arch-shaped transverse electric field. Since liquid crystal molecules exhibit alignment properties in accordance with the direction of an electric field of this kind, the same display is shown regardless of whether the viewing direction is the front direction or an oblique direction relative to the substrate surface, and consequently favorable viewing angle characteristics are obtained.

One substrate of the pair of substrates comprises a first polarizer, and another substrate of the pair of substrates comprises a second polarizer. Thus, the liquid crystal layer is disposed between the first polarizer and the second polarizer, and it is possible to utilize characteristics of the liquid crystal layer that change a polarizing state of light that passes through the liquid crystal layer to control an on state and an off state of the display.

A long axis of a comb tooth portion of a first comb-shaped electrode pair among the two or more sets of comb-shaped electrode pairs and a transmission axis of the first polarizer form an angle of substantially 45°, a long axis of a comb tooth portion of a second comb-shaped electrode pair among the two or more sets of a comb-shaped electrode pairs and a transmission axis of the second polarizer are in a parallel or orthogonal relationship with each other, the transmission axis of the first polarizer and the transmission axis of the second polarizer are orthogonal to each other, and the first comb-shaped electrode pair and the second comb-shaped electrode pair overlap with each other when the surfaces of the pair of substrates are viewed from a normal line direction. Thus, as described above, it is possible to control a change in the liquid crystal molecules from a state in which the display is off to a state in which the display is on by means of fall characteristics of the liquid crystal molecules, and the overall response speed is significantly improved. As used herein, the term “parallel” includes not only a completely parallel state, but also a substantially parallel state. In this case, the term “parallel” preferably refers to a state in which an angle that the relevant axes or the like form with respect to each other is within a range of 0±2°. Further, as used herein, the term “orthogonal” includes not only a completely orthogonal state, but also a state in which axes or the like are substantially orthogonal to each other. In this case, the term “orthogonal” preferably refers to a state in which an angle that the relevant axes or the like form with respect to each other is within a range of 90±2°. Furthermore, as used herein, the term “substantially 45°” specifically refers to an angle within a range of 45±2°.

The configuration of the liquid crystal display device of the present invention is not especially limited by other components as long as it essentially includes such components.

Preferable embodiments of the liquid crystal display device of the present invention are mentioned in more detail below.

Preferably, the first and second comb-shaped electrode pairs are disposed on respectively different substrates among the pair of substrates. By forming the first and second comb-shaped electrode pairs on different substrates to each other, each substrate can individually and efficiently exert the respective functions of transmitting light and blocking light. Further, in this case, the first comb-shaped electrode pair and a polarizer having a transmission axis that forms an angle of substantially 45° with a long axis of a comb tooth portion of the first comb-shaped electrode pair are formed on the same substrate, and the second comb-shaped electrode pair and a polarizer having a transmission axis that is parallel or orthogonal to a long axis of a comb tooth portion of the second comb-shaped electrode pair are formed on the same substrate. Hence, a deviation is less likely to arise with respect to positional matching between each axis that is provided for each substrate.

Preferably, the first and second comb-shaped electrode pairs are disposed on the same substrate among the pair of substrates. By forming the first and second comb-shaped electrode pairs on the same substrate, the process of manufacturing the electrodes can be performed by repeating the same process, and hence the manufacturing process is simplified. Further, a deviation is less likely to arise with respect to positional matching between the first comb-shaped electrode pair and second comb-shaped electrode pair. In this connection, the first and second comb-shaped electrode pairs are disposed on respectively different layers through an insulator. At this time, although either one of the first and second comb-shaped electrode pairs may be disposed on a side that is closer to the liquid crystal layer, it is preferable that a comb-shaped electrode pair that is on a side that applies a larger voltage is disposed furthest from the liquid crystal layer, since this arrangement allows a voltage to be applied more efficiently to the liquid crystal layer.

Preferably, one comb-shaped electrode of the first comb-shaped electrode pair is a pixel electrode that supplies a signal voltage, and another comb-shaped electrode of the first comb-shaped electrode pair is a common electrode that supplies a common voltage. It is possible to control the voltage for respective picture elements and realize a high-definition display by supplying separate signal voltages that correspond to respective picture elements to one comb-shaped electrode of the comb-shaped electrode pair in which the long axis of comb tooth is in a direction which forms an angle of substantially 45° with the transmission axis of the polarizer, and applying a common voltage to the other comb-shaped electrode of the comb-shaped electrode pair without differentiating among the picture elements.

Preferably, a signal voltage that is supplied by a pixel electrode of the second comb-shaped electrode pair is greater than a signal voltage that is supplied by the pixel electrode of the first comb-shaped electrode pair. As a result, the response speed is improved, and a different voltage can be applied into the liquid crystal layer even from a state in which a signal voltage is being retained in the liquid crystal layer.

Preferably, a space between each comb tooth portion of the second comb-shaped electrode pair is smaller than a space between each comb tooth portion of the first comb-shaped electrode pair. By making a space between each comb tooth portion shorter, an electric field formed between each comb tooth portion becomes denser, and hence a voltage applied into the liquid crystal layer can be increased. Accordingly, the response speed is improved, and a different voltage can be applied into the liquid crystal layer even from a state in which a signal voltage is being retained in the liquid crystal layer.

Preferably, a substrate having the first comb-shaped electrode pair has a plurality of rows of scanning signal lines, and thin film transistors that are connected to each of the plurality of rows of scanning signal lines; a scanning signal line of a given row among the plurality of rows of scanning signal lines applies a scanning voltage to a thin film transistor that is connected to a scanning signal line of the given row at a timing of supplying a signal voltage to the pixel electrode of the first comb-shaped electrode pair; and a scanning signal line of a row preceding the given row among the plurality of rows of scanning signal lines applies a scanning voltage to a thin film transistor that is connected to the scanning signal line of the row preceding the given row at a timing of supplying a signal voltage to the pixel electrode of the second comb-shaped electrode pair.

By applying a voltage to the second comb-shaped electrode pair using a scanning signal line of a row (n−x^{th} row) preceding a scanning signal line of a given n^{th} row, a gradation display can be obtained by means of fall characteristics of liquid crystal molecules and a black display can be obtained by means of high-speed rise characteristics of liquid crystal molecules generated by application of a high voltage. Further, a black display can be controlled using a scanning voltage that is applied to a scanning signal line that controls a timing at which a signal voltage is supplied, and thus an efficient configuration can be realized. Furthermore, since a scanning voltage is normally larger than a signal voltage, it is possible to switch to a black display even from a state in which a signal voltage is being retained in the liquid crystal layer, and thus the configuration is efficient.

Preferably, the scanning signal line of the row (n−x^{th} row) preceding the scanning signal line of the given n^{th} row precedes the scanning signal line of the given n^{th} row by two rows or more (x>1). This is because the response of liquid crystal molecules is longer than a writing time.

Preferably, a substrate having the first comb-shaped electrode pair has a plurality of rows of scanning signal lines, and thin film transistors that are connected to each of the plurality of rows of scanning signal lines; a scanning signal line of a given row among the plurality of rows of scanning signal lines applies a scanning voltage to a thin film transistor that is connected to a scanning signal line of the given row at a timing of supplying a signal voltage to the pixel electrode of the first comb-shaped electrode pair; and the pixel electrode of the first comb-shaped electrode pair is connected to a common electrode of the first comb-shaped electrode pair through a resetting thin film transistor that is controlled by a scanning signal line of a row that is next to the given row, or to a storage capacitor wiring that forms a capacitance between the pixel electrode of the first comb-shaped electrode pair and the storage capacitor wiring.

By placing a voltage within the liquid crystal layer that is applied by means of the first comb-shaped electrode pair in a non-application state (reset) during a period from after a signal voltage has been supplied to the second comb-shaped electrode pair by means of a scanning signal line of an n^{th} row until a voltage is applied by means of the first comb-shaped electrode pair, compared to a state in which a certain voltage is retained in the liquid crystal layer by the first comb-shaped electrode pair, the voltage that is applied by the second comb-shaped electrode pair can be increased and the response speed of liquid crystal molecules is improved. Further, since a configuration is adopted in which, simultaneously with a signal voltage being supplied to the first comb-shaped electrode pair by a scanning signal line of an n+1^{th} row, the voltage of a pixel electrode that is connected to a scanning signal line of the previous row (n^{th} row) to the n+1^{th} row is reset, the configuration can be considered efficient. In this connection, the reset timing can be adjusted in accordance with the scanning order of the rows of scanning signal lines.

### EFFECTS OF THE INVENTION

According to the liquid crystal display device of the present invention, it is possible to significantly improve a response speed in a liquid crystal display device of a type that generates a transverse electric field using a pair of electrodes that have comb teeth with respect to a liquid crystal layer including nematic liquid crystal having positive dielectric anisotropy in which the initial alignment is a vertical alignment.

### BRIEF DESCRIPTION OF THE DRAWINGS

FIG. 1 is an exploded perspective schematic view showing a relation between long axis directions of comb tooth portions of comb-shaped electrode pairs and transmission axis directions of polarizers of a liquid crystal display device according to Embodiment 1.

FIG. 2 is a planar schematic view showing respective manufacturing stages of the liquid crystal display device according to Embodiment 1.

FIG. 3 is a planar schematic view showing respective manufacturing stages of the liquid crystal display device according to Embodiment 1.

FIG. 4 is a planar schematic view showing respective manufacturing stages of the liquid crystal display device according to Embodiment 1.

FIG. 5 is a planar schematic view of a picture element unit of a TFT substrate included in the liquid crystal display device according to Embodiment 1.

FIG. 6 is a planar schematic view that illustrates Modification Example 1 of comb tooth portions of a comb-shaped electrode pair included in the liquid crystal display device according to Embodiment 1.

FIG. 7 is a planar schematic view that illustrates Modification Example 2 of comb tooth portions of a comb-shaped electrode pair included in the liquid crystal display device according to Embodiment 1.

FIG. 8 is a planar schematic view of a picture element unit of an opposed substrate included in the liquid crystal display device according to Embodiment 1.

FIG. 9 is a planar schematic view of a picture element unit when a TFT substrate and an opposed substrate included in the liquid crystal display device according to Embodiment 1 are superimposed with respect to each other.

FIG. 10 is a cross-sectional schematic diagram of the liquid crystal display device according to Embodiment 1 that, when taking gate wiring of a given n^{th} row as a basis, illustrates the behavior of liquid crystal molecules in a state in which a voltage is applied to a pixel electrode connected to gate wiring of an n−x^{th} row.

FIG. 11 is a cross-sectional schematic diagram of the liquid crystal display device according to Embodiment 1 that illustrates the behavior of liquid crystal molecules in a state in which a voltage is applied to a pixel electrode connected to gate wiring other than gate wiring of the n−x^{th} row, including the n^{th} row.

FIG. 12 is a timing chart that illustrates sizes and timings of voltages that are applied to the liquid crystal display device according to Embodiment 1.

FIG. 13 includes schematic diagrams illustrating the structure of each member of the liquid crystal display device according to Embodiment 1 in a state in which light passes through the respective members, as well as respective stages showing a polarizing state of transmitted light, which illustrate a case at the time of a black display.

FIG. 14 includes schematic diagrams illustrating the structure of each member of the liquid crystal display device according to Embodiment 1 in a state in which light passes through the respective members, as well as respective stages showing a polarizing state of transmitted light, which illustrate a case at a time of a gradation display.

FIG. 15 is a graph showing response characteristics of the liquid crystal display device according to Embodiment 1.

FIG. 16 is a planar schematic view showing respective manufacturing stages of a liquid crystal display device according to Embodiment 2.

FIG. 17 is a planar schematic view showing respective manufacturing stages of the liquid crystal display device according to Embodiment 2.

FIG. 18 is a planar schematic view showing respective manufacturing stages of the liquid crystal display device according to Embodiment 2.

FIG. 19 is a planar schematic view of a picture element unit of a TFT substrate included in the liquid crystal display device according to Embodiment 2.

FIG. 20 is a planar schematic view of a storage capacitance formation portion that is provided outside a display portion of an opposed substrate included in the liquid crystal display device according to Embodiment 2.

FIG. 21 is a planar schematic view of a picture element unit when a TFT substrate and an opposed substrate included in the liquid crystal display device according to Embodiment 2 are superimposed with respect to each other.

FIG. 22 is a cross-sectional schematic diagram of the liquid crystal display device according to Embodiment 2 that, in particular, when taking gate wiring of a given n^{th} row as a basis, illustrates the behavior of liquid crystal molecules in a state in which a voltage is applied to a pixel electrode connected to gate wiring of n−x^{th} to n−1^{th} rows.

FIG. 23 is a cross-sectional schematic diagram of the liquid crystal display device according to Embodiment 2 that illustrates the behavior of liquid crystal molecules in a state in which a voltage is applied to a pixel electrode connected to gate wiring of an n^{th} row to, and 1^{st} row to an n−x−1^{th} row.

FIG. 24 is a timing chart that illustrates sizes and timings of voltages that are applied to the liquid crystal display device according to Embodiment 2.

FIG. 25 is a cross-sectional schematic diagram of a liquid crystal display device according to Embodiment 3 in which an opposed comb-shaped electrode pair are disposed between a TFT comb-shaped electrode pair and a liquid crystal layer that, when taking gate wiring of a given n^{th} row as a basis, illustrates the behavior of liquid crystal molecules in a state in which a voltage is applied to a pixel electrode connected to gate wiring of n−x^{th} to n−1^{th} rows.

FIG. 26 is a cross-sectional schematic diagram of the liquid crystal display device according to Embodiment 3 in which an opposed comb-shaped electrode pair are disposed between a TFT comb-shaped electrode pair and a liquid crystal layer, that illustrates the behavior of liquid crystal molecules in a state in which a voltage is applied to a pixel electrode connected to gate wiring of an n^{th} row to, and 1^{st} row to an n−x−1^{th} row.

FIG. 27 is a cross-sectional schematic diagram of the liquid crystal display device according to Embodiment 3 in which a TFT comb-shaped electrode pair are disposed between an opposed comb-shaped electrode pair and a liquid crystal layer that, when taking gate wiring of a given n^{th} row as a basis, illustrates the behavior of liquid crystal molecules in a state in which a voltage is applied to a pixel electrode connected to gate wiring of n−x^{th} to n−1^{th} rows.

FIG. 28 is a cross-sectional schematic diagram of the liquid crystal display device according to Embodiment 3 in which a TFT comb-shaped electrode pair are disposed between an opposed comb-shaped electrode pair and a liquid crystal layer, that illustrates the behavior of liquid crystal molecules in a state in which a voltage is applied to a pixel electrode connected to gate wiring of an n^{th} row to, and 1^{st} row to an n−x−1^{th} row.

FIG. 29 includes schematic diagrams illustrating the structure of each member of the liquid crystal display device according to Embodiment 3 in a state in which light passes through the respective members, as well as respective stages showing a polarizing state of transmitted light, which illustrate a case at the time of a black display.

FIG. 30 includes schematic diagrams illustrating the structure of each member of the liquid crystal display device according to Embodiment 3 in a state in which light passes through the respective members, as well as respective stages showing a polarizing state of transmitted light, which illustrate a case at the time of a gradation display.

FIG. 31 is a perspective schematic view illustrating the configuration of a liquid crystal display device of a type that generates a transverse electric field using a pair of electrodes that have comb teeth with respect to a liquid crystal layer including nematic liquid crystal having positive dielectric anisotropy in which the initial alignment of the liquid crystals is a vertical alignment.

FIG. 32 is a schematic diagram that illustrates equipotential curves in a cell when a voltage of 7V is applied thereto.

FIG. 33 is a graph that illustrates rise response characteristics and fall response characteristics of a liquid crystal display device of a type that generates a transverse electric field using a pair of electrodes that have comb teeth with respect to a liquid crystal layer including nematic liquid crystals having positive dielectric anisotropy in which the initial alignment of the liquid crystals is a vertical alignment.

### MODES FOR CARRYING OUT THE INVENTION

The present invention will be mentioned in more detail referring to the drawings in the following embodiments, but is not limited to these embodiments.

### Embodiment 1

A liquid crystal display device according to Embodiment 1 is of a type that controls an image display by controlling the alignment of liquid crystal molecules whose initial alignment is a vertical alignment by generating an arch-shaped transverse electric field with respect to a liquid crystal layer by means of a pair of electrodes that are formed in the same substrate.

The liquid crystal display device according to Embodiment 1 includes a liquid crystal display panel having a pair of substrates that are arranged facing each other, and a liquid crystal layer that is sandwiched between the pair of substrates. More specifically, the liquid crystal display device of Embodiment 1 includes, in order from a back surface side to an observation surface side, a TFT substrate, a liquid crystal layer, and an opposed substrate. The liquid crystal layer contains nematic liquid crystals having positive dielectric anisotropy (Δ∈>0). The liquid crystal display device of Embodiment 1 also includes a backlight unit on a back surface side of the liquid crystal display panel. Light emitted from the backlight unit passes through the TFT substrate, the liquid crystal layer, and the opposed substrate in that order.

In the liquid crystal display device according to Embodiment 1, a display region is constituted by a plurality of picture elements (subpixels) that are formed in a matrix shape, and a configuration is adopted so that driving can be controlled for the respective picture elements. A plurality of the picture elements (for example, three picture elements including a red, a green, and a blue picture element) constitute a single pixel. In this connection, as used herein, the term “picture element” refers to an area that is surrounded by adjacent gate wirings and source wirings.

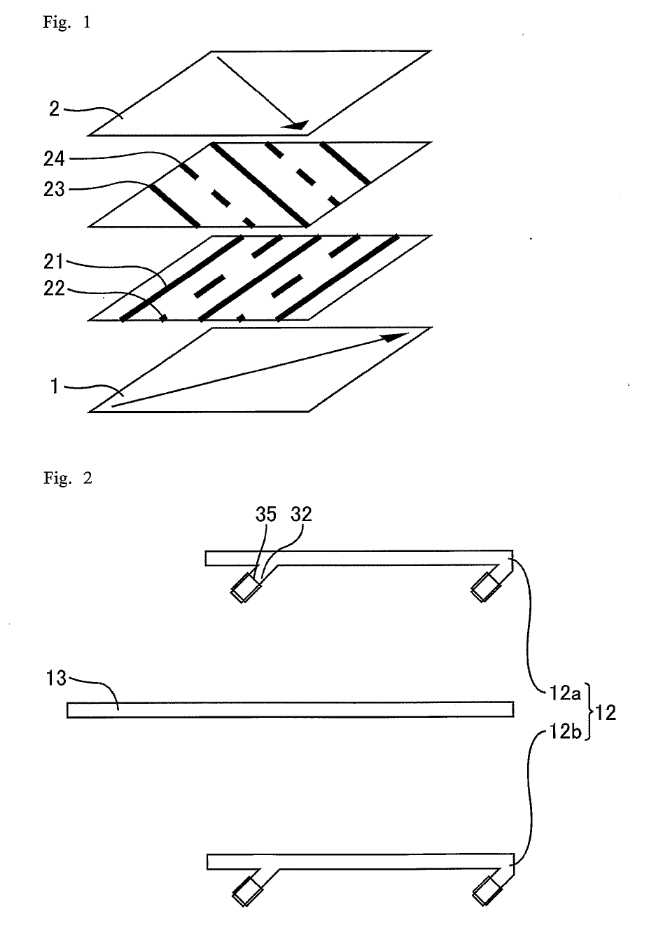

FIG. 1 is an exploded perspective schematic view showing the relation between long axis directions of comb tooth portions of comb-shaped electrode pairs and transmission axis directions of polarizers of the liquid crystal display device according to Embodiment 1. As shown in FIG. 1, the liquid crystal display device according to Embodiment 1 has two sets of comb-shaped electrodes pairs in which comb tooth portions of the respective comb-shaped electrodes are alternately disposed with each other with a certain space therebetween, and a first polarizer 1 and a second polarizer 2 that sandwich the two sets of comb-shaped electrode pairs therebetween. Further, a liquid crystal layer is disposed between the first polarizer 1 and the second polarizer 2.

The polarizer on the lower side in FIG. 1 is the first polarizer 1, and the polarizer on the upper side is the second polarizer 2. Both the first polarizer 1 and the second polarizer 2 have a transmission axis. Light that passes through the respective polarizers is only light that has a vibration direction in the direction of the transmission axis (arrow direction in FIG. 1) of the relevant polarizer. The transmission axis of the first polarizer 1 and the transmission axis of the second polarizer 2 are orthogonal to each other, and are in a so-called “cross Nichol” configuration.

Although the respective sets constituted by a comb-shaped electrode pair are formed on respectively different plane surfaces, each of the comb-shaped electrodes constituting a comb-shaped electrode pair is formed on the same plane surface. One of the comb-shaped electrode pairs is composed of pixel electrodes 21 and 23 to which a signal voltage is supplied, and the other of the comb-shaped electrode pairs is composed of common electrodes 22 and 24 to which a common electrode is supplied. Each of the comb-shaped electrodes 21, 22, 23 and 24 has rectilinear-shaped comb tooth portions, and the long axes of the respective comb tooth portions are parallel with each other. Solid lines in FIG. 1 represent the comb tooth portions of the pixel electrodes 21 and 23, and broken lines in FIG. 1 represent the comb tooth portions of the common electrodes 22 and 24.

Among the two sets of comb-shaped electrode pairs, a comb-shaped electrode pair that is nearer the first polarizer 1 is a first comb-shaped electrode pair, and a comb-shaped electrode pair that is nearer the second polarizer 2 is a second comb-shaped electrode pair. As shown in FIG. 1, an angle of substantially 45° is formed between the long axis of the comb tooth portion of the first comb-shaped electrode pair and the transmission axis of the first polarizer 1. The long axis of the comb tooth portion of the second comb-shaped electrode pair and the transmission axis of the second polarizer 2 are parallel with each other. Further, the first comb-shaped electrode pair and the second comb-shaped electrode pair are overlapped with respect to each other when viewing the surfaces of the aforementioned pair of substrates from a normal line direction. In this connection, although FIG. 1 illustrates a state in which the long axis of the comb tooth portion of the second comb-shaped electrode pair and the transmission axis of the second polarizer 2 are parallel with each other, even if these axes are orthogonal to each other, the polarizing state of light is changed in a similar manner.

This arrangement relationship is the basic configuration of the comb-shaped electrode pairs and the polarizers, and hence the behavior of liquid crystal molecules inside the liquid crystal layer is separately controlled by the first comb-shaped electrode pair and the second comb-shaped electrode pair, respectively. In particular, with respect to liquid crystal molecules having positive dielectric anisotropy and whose initial alignment is a vertical alignment, it is possible to adjust switching of the display device using an alignment change to a faster direction (from a horizontal direction to a vertical direction), and response characteristics can be significantly improved for the overall display device.

The plane surface configuration of the display regions of the liquid crystal display device according to Embodiment 1 will now be described in further detail.

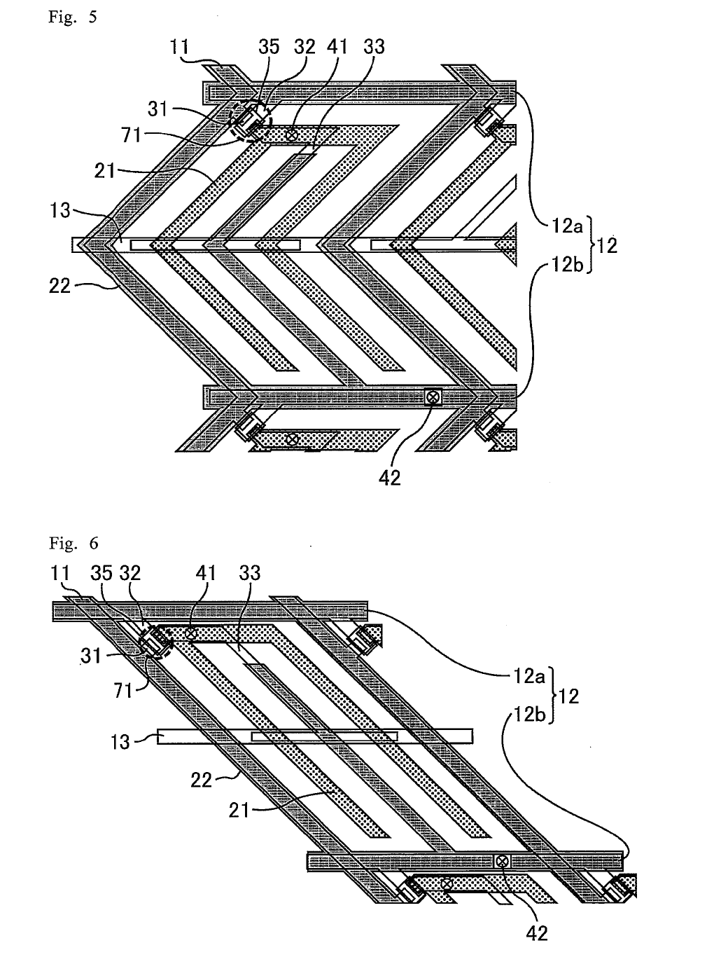

FIG. 5 is a planar schematic view of a picture element unit of a TFT substrate included in the liquid crystal display device of Embodiment 1. As shown in FIG. 5, the TFT substrate is an active matrix type substrate that has a plurality of columns of source wiring (signal electrode lines) 11 that transmit an image signal, a plurality of rows of gate wiring (scanning signal lines) 12 that transmit a scanning signal, and a plurality of thin film transistors (TFTs) 71 that are switching elements are provided in a one-to-one arrangement with respect to each picture element. Each TFT 71 is provided in the vicinity of a portion where the source wiring 11 and the gate wiring 12 intersect, and has a source electrode 31 that is connected to the source wiring 11, a gate electrode 32 that is connected to the gate wiring 12, and a drain electrode 33 that is connected to the source electrode 31 through a semiconductor layer 35. The TFT substrate has, in picture element units, a comb-shaped electrode pair (first comb-shaped electrode pair) constituted by a pixel electrode 21 and a common electrode 22 for applying a certain voltage to the liquid crystal layer. Hereunder, the pixel electrode on the TFT substrate side is also referred to as “TFT pixel electrode 21” and the common electrode on the TFT substrate side is also referred to as “TFT common electrode 22”.

The source wiring 11 is connected to a source driver, and a source voltage (signal voltage) that serves as an image signal that is supplied from the source driver is applied to the TFT pixel electrode 21 via the TFT 71. The gate wiring 12 is connected to a gate driver. A gate voltage (scanning voltage) that serves as a scanning signal that is supplied in pulses at a predetermined timing from the gate driver is applied to the TFT 71. A common voltage that is maintained at a constant voltage is applied to the TFT common electrode 22.

Hereunder, the configuration according to Embodiment 1 is described in detail by describing each manufacturing stage of the liquid crystal display device using FIGS. 2 to 5. FIGS. 2 to 5 are planar schematic views illustrating respective manufacturing stages of the liquid crystal display device of Embodiment 1.

First, as shown in FIG. 2, as the gate wirings 12, a plurality of wirings are provided so that the respective wirings extend rectilinearly in the row direction and are parallel with each other. Further, as Cs wiring 13 for forming a storage capacitance, wiring is provided so as to extend rectilinearly in the row direction and in parallel with the gate wiring 12 at a position that is located at a gap between the gate wirings 12a and 12b. Furthermore, wiring that serves as the gate electrode 32 of the TFT is extended from a portion of the gate wirings 12a and 12b, respectively. The semiconductor layer 35 is provided through a gate insulator at a position that overlaps with the gate electrode 32.

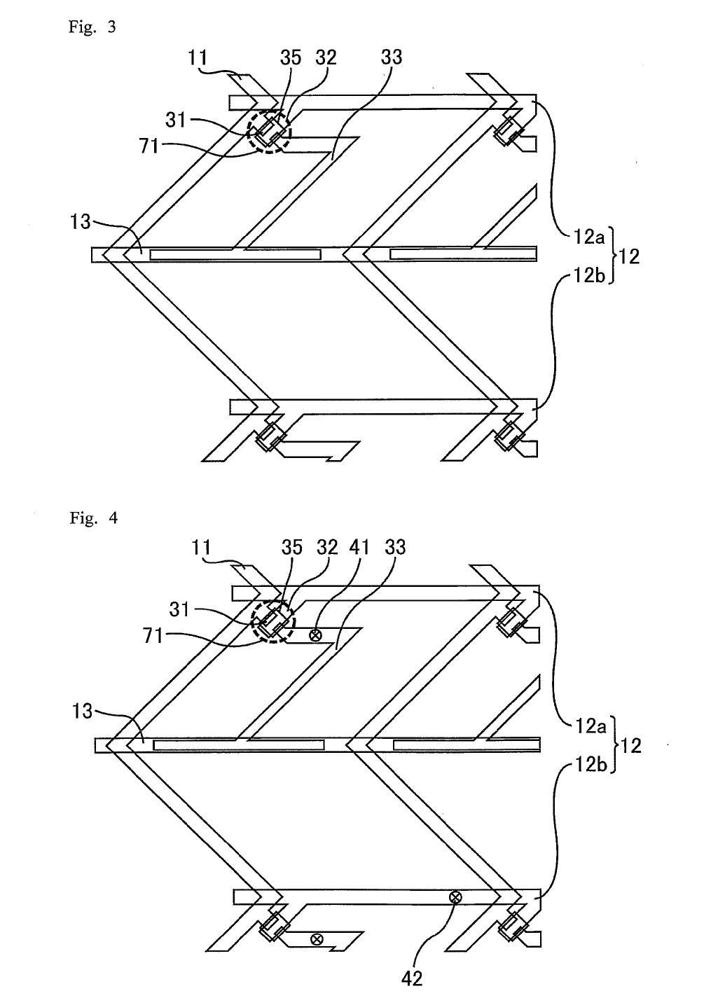

Next, as shown in FIG. 3, as the source wirings 11, a plurality of wirings are provided so that the respective wirings extend rectilinearly in the column direction, and are parallel with each other in a semi-inverted V shape in picture element units. Thus, each source wiring 11 has a zigzag shape when viewed with respect to the entire display region. Further, each source wiring 11 is provided so as to intersect with the gate wiring 12 and the Cs wiring 13 through the insulator.

When forming the drain electrode 33 of the TFT, the drain electrode 33 is extended as far as the center of the picture element. Further, a rectilinear area (hereunder, also referred to as “Cs electrode”) is provided by further extending drain lead-out wiring 13 to a position that overlaps with the Cs wiring through the insulator. Thus, a storage capacitance of a constant amount is formed between the Cs wiring 13 and the Cs electrode 33, and an image signal is stably retained.

Next, as shown in FIG. 4, a contact portion (first contact portion) 41 is provided at one portion of the drain electrode 33. The first contact portion 41 is an area provided in the insulator that is formed between the drain electrode 33 and the TFT pixel electrode 21 to connect the drain electrode 33 and the TFT pixel electrode 21. Thus, the TFT 71 is connected to the TFT pixel electrode 21 via the drain electrode 33 and the first contact portion 41, and an image signal from the source wiring 11 is supplied at a predetermined timing to the TFT pixel electrode 21 via the TFT 71 that has been placed in an “on” state for a certain time period by input of a scanning signal.

Further, a contact portion (second contact portion) 42 is provided in one portion of the gate wiring 12. The second contact portion 42 is an area that is provided to connect the gate wiring 12 on the TFT substrate side and the pixel electrode on the opposed substrate side. Thus, a scanning signal that is supplied through the gate wiring 12 on the TFT substrate side is also supplied to the pixel electrode on the opposed substrate side via the second contact portion 42.

Next, the TFT pixel electrode 21 and the TFT common electrode 22 are provided as shown in FIG. 5.

The TFT pixel electrode 21 is provided so as to have a trunk portion and a plurality of comb tooth portions that protrude planarly from a part of the trunk portion.

The TFT common electrode 22 is formed on a different layer to the source wiring 11 and the gate wiring 12 through the insulator, and is provided so as to overlap with the source wiring 11 and the gate wiring 12, respectively. The area of the TFT common electrode 22 that overlaps with the source wiring 11 and the gate wiring 12 is the trunk portion. The trunk portion of the TFT common electrode 22 constitutes a matrix shape that corresponds to a combined shape of the source wiring 11 and the gate wiring 12 as viewed in terms of the overall display region. The TFT common electrode 22 is provided such that comb tooth portions protrude planarly from a part of the trunk portion.

The comb tooth portions of the TFT pixel electrode 21 and the comb tooth portions of the TFT common electrode 22 each form a semi-inverted V shape in picture element units, and are provided so as to be parallel with each other. Further, the comb tooth portions of the TFT pixel electrode 21 and the comb tooth portions of the TFT common electrode 22 are disposed so as to be alternately disposed with each other with a certain space therebetween.

Thus, the comb tooth portions of the TFT pixel electrode 21 and the comb tooth portions of the TFT common electrode 22 are provided to be also parallel with the source wiring 11. Accordingly, the comb tooth portions of the TFT pixel electrode 21 are also in a parallel relation with a part of the trunk portion of the TFT common electrode 22.

Preferably, the width of the comb tooth portions of the TFT pixel electrode 21 and the comb tooth portions of the TFT common electrode 22 is set to between 1 and 6 μm, and more preferably between 2.5 and 4.0 μm. Further, a width of drain lead-out wiring 16 is preferably set to between 1 and 6 μm.

The size of the space between the comb tooth portions of the TFT pixel electrode 21 and the comb tooth portions of the TFT common electrode 22 is preferably between 2.5 and 20.0 μm, and more preferably is between 4.0 and 12.0 μm. If the size exceeds 20.0 μm or is less than 2.5 μm, the transmittance may decrease.

Examples of materials that can be used as the material of the TFT pixel electrode 21 and the TFT common electrode 22 include a metal oxide such as indium tin oxide (ITO) or indium zinc oxide (IZO), or a metal such as aluminum or chrome. From the viewpoint of improving transmittance, a translucent metal oxide is preferable. In this connection, since the TFT pixel electrode 21 and the TFT common electrode 22 that form a pair are disposed on the same layer, the manufacturing process is simplified by using the same material for these electrodes.

The common electrode 22 on the TFT substrate side and the common electrode on the opposed substrate side are connected at an area (not shown) other than a picture element. Therefore, the common electrode on the opposed substrate side shares the electric potential of the common electrode 22 on the TFT substrate side.

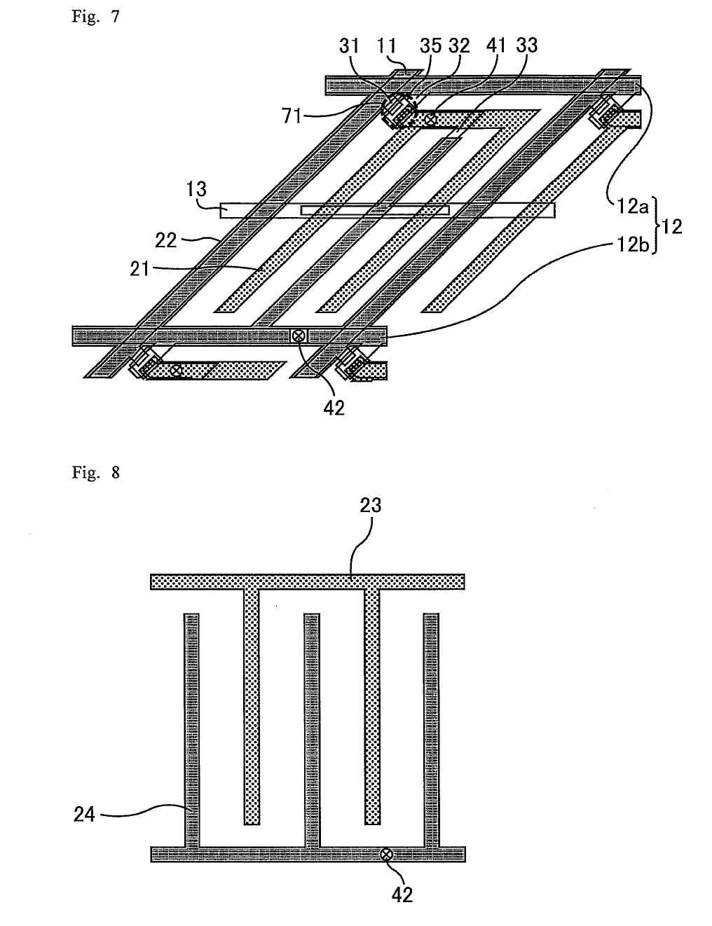

Thus, a TFT substrate having a basic configuration as shown in FIG. 5 is obtained. In this connection, the comb tooth portions of the TFT pixel electrode 21 and the comb tooth portions of the TFT common electrode 22 in FIG. 5 each have a semi-inverted V shape having a symmetrical structure that takes the Cs wiring as an axis of symmetry. However, as shown in FIG. 6 and FIG. 7, portions that are rectilinear in a diagonal direction relative to the extending direction of the gate wiring 12 may be used as the comb tooth portions of the TFT pixel electrode 21 and the comb tooth portions of the TFT common electrode 22 according to Embodiment 1. In this case, the source wiring 11 needs to be extended in a diagonal direction relative to the extending direction of the gate wiring 12 in conformity with the shape of the comb tooth portions of the TFT pixel electrode 21 and the comb tooth portions of the TFT common electrode 22.

FIG. 6 is a planar schematic view that illustrates Modification Example 1 of comb tooth portions of a comb-shaped electrode pair included in the liquid crystal display device of Embodiment 1, and FIG. 7 is a planar schematic view that illustrates Modification Example 2 of comb tooth portions of a comb-shaped electrode pair included in the liquid crystal display device of Embodiment 1.

FIG. 8 is a planar schematic view of a picture element unit of an opposed substrate included in the liquid crystal display device of Embodiment 1. As shown in FIG. 8, the opposed substrate has a comb-shaped electrode pair (second comb-shaped electrode pair) constituted by the pixel electrode 23 and the common electrode 24 for applying a certain voltage to the liquid crystal layer in picture element units. Hereunder, the pixel electrode on the opposed substrate side is also referred to as “opposed pixel electrode 23” and the common electrode on the opposed substrate side is also referred to as “opposed common electrode 24”.

The opposed pixel electrode 23 has a trunk portion and a plurality of comb tooth portions that extend from one part of the trunk portion. The opposed common electrode 24 also has a trunk portion and a plurality of comb tooth portions that extend from one part of the trunk portion.

The comb tooth portions of the opposed pixel electrode 23 and the comb tooth portions of the opposed common electrode 24 are rectilinear, and are provided so as to be parallel with each other. The comb tooth portions of the opposed pixel electrode 23 and the comb tooth portions of the opposed common electrode 24 are disposed so as to be alternately disposed with each other with a certain space therebetween.

The opposed pixel electrode 23 connects with the gate wiring 12 included in the TFT substrate through a contact portion 42.

The opposed common electrode 24 connects with the TFT common electrode 22 included in the TFT substrate at an area other than a picture element. Accordingly, the TFT common electrode 22 and the opposed common electrode 24 are equipotential.

The gate wiring of the TFT substrate as shown in FIG. 8 or gate wiring that is formed separately and independently on the opposed substrate may be utilized as gate wiring for applying a gate voltage to the comb-shaped electrode pair of the opposed substrate. Further, a TFT may be separately formed on the opposed substrate. When utilizing the gate wiring of the TFT substrate, it is necessary to route a wiring through a columnar spacer or the like that is provided between the TFT substrate and the opposed substrate at a position that is outside a display region of the TFT substrate. When drawing in the gate wiring using a columnar spacer, since liquid crystal molecules may be disturbed around the columnar spacer, it is preferable to provide a light shielding portion at a region that overlaps with the columnar spacer.

The width of the comb tooth portions of the opposed pixel electrode 23 and the comb tooth portions of the opposed common electrode 24 can be made the same as the width of the comb tooth portions of the TFT pixel electrode 21 and the comb tooth portions of the TFT common electrode 22.

Although the size of the space between the comb tooth portions of the opposed pixel electrode 23 and the comb tooth portions of the opposed common electrode 24 can be made the same as the size of the space between the comb tooth portions of the TFT pixel electrode 21 and the comb tooth portions of the TFT common electrode 22, preferably the size of the space between the comb tooth portions of the opposed pixel electrode 23 and the comb tooth portions of the opposed common electrode 24 is smaller than the size of the space between the comb tooth portions of the TFT pixel electrode 21 and the comb tooth portions of the TFT common electrode 22. Thus, the density of an electric field between the comb tooth portions of the opposed pixel electrode 23 and the comb tooth portions of the opposed common electrode 24 increases, and the response speed of liquid crystal molecules improves.

The same materials that are used for the TFT pixel electrode 21 and TFT common electrode 22 can be used for the opposed pixel electrode 23 and the opposed common electrode 24.

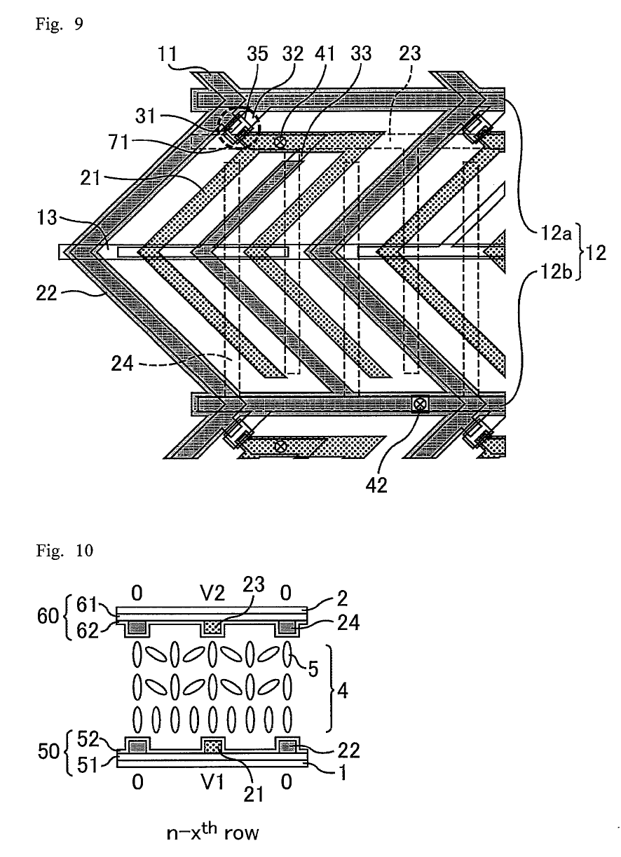

FIG. 9 is a planar schematic view of a picture element unit when the TFT substrate and the opposed substrate included in the liquid crystal display device of Embodiment 1 are superimposed with respect to each other. Portions indicated by solid lines in FIG. 9 represent constituent members on the TFT substrate side, and potions indicated by broken lines represent constituent members on the opposed substrate side. As shown in FIG. 9, when the TFT substrate and the opposed substrate are superimposed, the long axis of the comb tooth portion of the comb-shaped electrodes 21 and 22 constituting the first comb-shaped electrode pair and the long axis of the comb tooth portion of the comb-shaped electrodes 23 and 24 constituting the second comb-shaped electrode pair form an angle of substantially 45°.

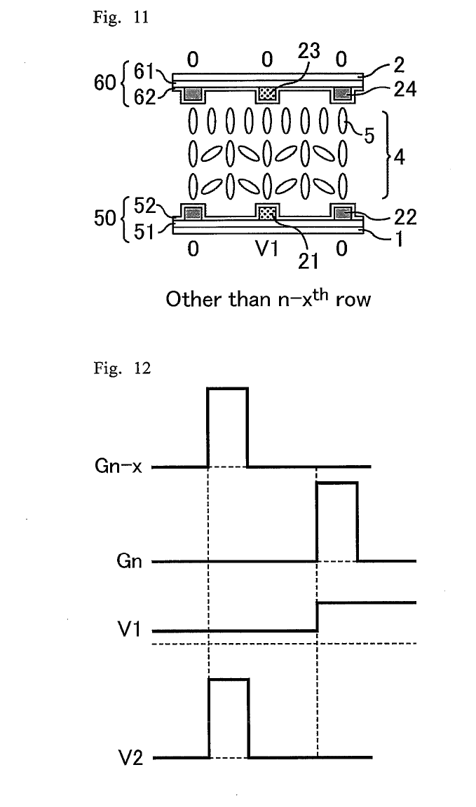

The configuration and driving method of the liquid crystal display device according to Embodiment 1 will now be described in detail. FIG. 10 and FIG. 11 are cross-sectional schematic diagrams of the liquid crystal display device according to Embodiment 1, which, in particular, illustrate the behavior of liquid crystal molecules in detail. FIG. 10 illustrates the behavior of liquid crystal molecules in a state in which a voltage is applied to a pixel electrode connected to gate wiring of an n−x^{th} row, when gate wiring of a given n^{th} row is taken as a basis. FIG. 11 illustrates the behavior of liquid crystal molecules in a state in which a voltage is applied to a pixel electrode connected to gate wiring other than gate wiring of the n−x^{th} row, including the n^{th} row.

As shown in FIG. 10 and FIG. 11, the liquid crystal display device of Embodiment 1 includes a liquid crystal display panel that has a pair of substrates constituted by a TFT substrate 50 and an opposed substrate 60, and a liquid crystal layer 4 between the TFT substrate 50 and the opposed substrate 60.

The TFT substrate 50 includes a transparent substrate 51 having translucency that is made of glass or resin or the like as a main constituent, and also has the first comb-shaped electrode pair on a surface on the liquid crystal layer 4 side of the transparent substrate 51, and the first polarizer 1 on a surface on the opposite side to the liquid crystal layer of the transparent substrate 51. The comb teeth of each of the pixel electrode 21 and the common electrode 22 that constitute the first comb-shaped electrode pair are alternately disposed with a certain space therebetween.

The opposed substrate 60 includes a transparent substrate 61 having translucency that is made of glass or resin or the like as a main constituent, and also has the second comb-shaped electrode pair on a surface on the liquid crystal layer 4 side of the transparent substrate 61, and the second polarizer 2 on a surface on the opposite side to the liquid crystal layer of the transparent substrate 61. The comb teeth of each of the pixel electrode 23 and the common electrode 24 that constitute the second comb-shaped electrode pair are alternately disposed with a certain space therebetween.

In Embodiment 1, a color display can be realized by providing color filters in the TFT substrate 50 or the opposed substrate 60. The color filters, for example, include three colors, namely, red, green and blue. By disposing a color filter of one color so as to correspond to a single picture element, it is possible to individually drive each color, and a desired color can be obtained in pixel units in which red, green, and blue are taken as one set. In this connection, the colors of the color filter need not necessarily be these colors, and a configuration may be adopted in which pixels are constituted by a set of color filters that include four or more colors. Further, a black matrix (BM) of a black color may be disposed between the color filters of each color, and thus color mixing and light leakage can be prevented.

The TFT substrate 50 and the opposed substrate 60 are adhered to each other by a sealing agent that is applied along the outer circumference of the display region via a columnar spacer such as a resin.

Vertical alignment layers 52 and 62 are formed on the respective surfaces that contact the liquid crystal layer 4 of the TFT substrate 50 and the opposed substrate 60. By means of the vertical alignment layers 52 and 62, the initial alignment of the liquid crystal molecules can be made a vertical alignment relative to the surface of the TFT substrate 50 and the surface of the opposed substrate 60. A resin such as polyimide may be mentioned as an example of the material of the vertical alignment layers 52 and 62.

As shown in FIG. 10 and FIG. 11, when an arch-shaped transverse electric field is formed between the comb tooth portions of the comb-shaped electrodes 21 and 22 formed on the TFT substrate side, or between the comb tooth portions of the comb-shaped electrodes 23 and 24 formed on the opposed substrate side, a change arises in the alignment properties of liquid crystal molecules 5 along the arch-shaped transverse electric field. A group of liquid crystal molecules 5 that receive the influence of the electric field in this manner exhibit an overall bent alignment in the lateral direction that is symmetrical around an intermediate region between the comb tooth portions.

However, as shown in FIG. 10 and FIG. 11, since there is no electric field at the liquid crystal molecules 5 positioned at the ends of the arch-shaped transverse electric field, that is, the liquid crystal molecules 5 positioned directly above the pixel electrodes 21 and 23 and the common electrodes 22 and 24, the liquid crystal molecules 5 in question remain aligned in the vertical direction relative to the surfaces of the substrates 50 and 60. Further, the liquid crystal molecules 5 that are positioned in an intermediate region between comb tooth portions and that are at a furthest distance from comb teeth within regions between the comb tooth portions also remain aligned in the vertical direction relative to the surfaces of the pair of substrates 50 and 60.

As shown in FIG. 10 and FIG. 11, according to Embodiment 1, the voltage size and timing differs between a voltage that is applied to the comb-shaped electrode pair on the TFT substrate 50 side and a voltage that is applied to the comb-shaped electrode pair on the opposed substrate 60 side. By varying the size and timing of the voltages in this manner, the respective combinations of comb-shaped electrode pairs can separately control the alignment properties of the liquid crystal molecules.

FIG. 12 is a timing chart that shows the sizes and timings of voltages that are applied to the liquid crystal display device of Embodiment 1. Reference characters Gn−x and Gn in FIG. 12 denote gate voltages, and reference characters V1 and V2 denote source voltages. Further, reference character V1 denotes a voltage that is applied to a pixel electrode of the first comb-shaped electrode pair, and reference character V2 denotes a voltage that is applied to a pixel electrode of the second comb-shaped electrode pair. As shown in FIG. 12, when a gate voltage is applied to gate wiring of the n−x^{th} row, the gate voltage is applied to the opposed pixel electrode and a potential difference of V2 is formed between the opposed pixel electrode and the opposed common electrode. Next, when a gate voltage is applied to gate wiring other than that of the n−x^{th} row, including the n^{th} row, a source voltage is applied to the TFT pixel electrode through the semiconductor layer of the TFT and a potential difference of V1 is formed between the TFT pixel electrode and the TFT common electrode. In this case, a voltage applied to each common electrode is assumed to be 0V.

The opposed pixel electrode 23 is connected to the gate wiring through the second contact portion 42, and as shown in FIG. 10, at a timing at which a voltage is applied to the gate wiring of the n−x^{th} row, in a state in which the voltage V1 formed inside the liquid crystal layer by means of the comb-shaped electrode pair on the TFT substrate 50 by the voltage application of the previous cycle is being retained, the voltage V2 is applied into the liquid crystal layer 4 by means of the comb-shaped electrode pair on the opposed substrate 60 side. More specifically, it is preferable that V2 is larger than V1 by several volts at least.

According to Embodiment 1, since V2 is set to a larger value than V1, by application of the voltage V2, the liquid crystal molecules 5 exhibit an alignment along an arch-shaped transverse electric field formed between the comb-shaped electrode pair on the opposed substrate 60 side. That is, since the liquid crystal molecules 5 align in a direction that is orthogonal to the long axis of the comb-shaped electrode pair, light that passes through the liquid crystal layer 4 in this state is polarized to polarized light having an axis in a direction that is orthogonal to the transmission axis of the polarizer (second polarizer) 2 on the opposed substrate 60 side. As a result, light is blocked by the second polarizer 2 and the display enters an “off” (black display) state.

The response to enter a black display state in this case is performed by means of an alignment change in which a high voltage is applied to liquid crystal molecules that were originally aligned in a direction at an angle of 45 degrees relative to the direction of the transmission axis of the polarizer to thereby cause the liquid crystal molecules to rotate in the horizontal or vertical direction relative to the direction of the transmission axis of the polarizer. The aforementioned response compares favorably with a response performed in the conventional manner by means of an alignment change that causes liquid crystal molecules that were originally aligned in a horizontal direction relative to a substrate surface to fall in the vertical direction. Further, since a response from a black display state to a gradation display state uses fall characteristics that cause liquid crystal molecules that were aligned in the direction of the transmission axis of the polarizer by means of a high electric field to rotate while applying a lower voltage thereto, response characteristics of a change to a gradation display state are improved.

In this connection, according to Embodiment 1, the gate voltage V2 of the gate wiring of the TFT substrate 50 is used as a voltage that is applied to the opposed pixel electrode 23, and the voltage is a sufficient size with respect to the source voltage V1 that is applied to the TFT pixel electrode 21.

On the other hand, as shown in FIG. 11, the gate wiring is connected to the TFT pixel electrode 21, and the voltage V1 is applied into the liquid crystal layer 4 by means of the comb-shaped electrode pair on the TFT substrate 50 side.

By application of the voltage V1, the liquid crystal molecules 5 exhibit an alignment along an arch-shaped transverse electric field formed between the comb-shaped electrode pair on the TFT substrate 50. That is, since the liquid crystal molecules 5 align in a direction that is orthogonal to the long axis of the comb-shaped electrode pair, light that passes through the liquid crystal layer in this state is polarized to polarized light having an axis in a direction that is orthogonal to the transmission axis of the polarizer (first polarizer) 1 on the TFT substrate 50 side. As a result, light that has passed through the liquid crystal layer 4 passes through the second polarizer 2, and thus the display enters an “on” (gradation display) state. The change in alignment in this case is a change to a direction in which the voltage falls, and originally the response characteristics are favorable.

The behavior of liquid crystal molecules in the liquid crystal layer as well as changes in the polarizing state of light in the liquid crystal display device of Embodiment 1 described above will now be described in further detail for the respective timings.

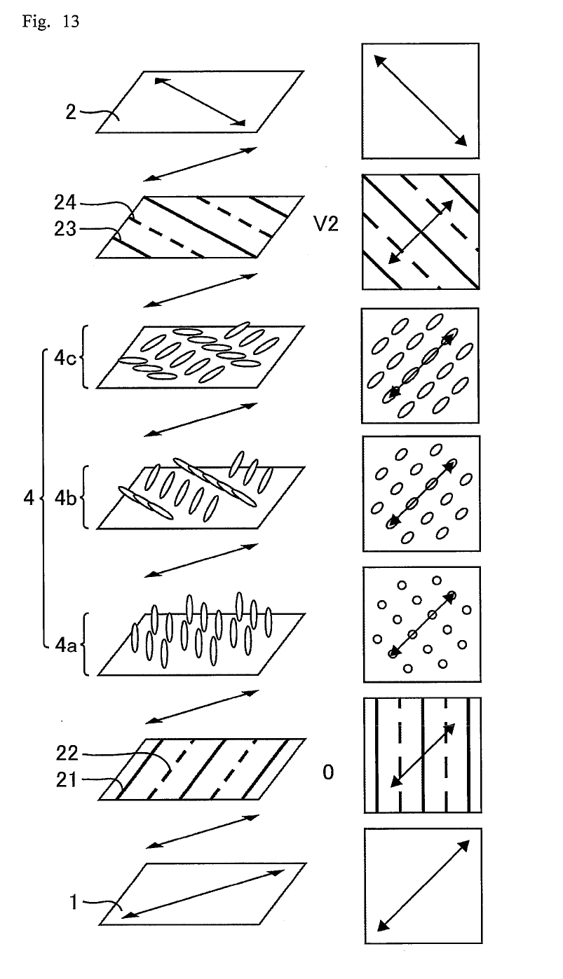

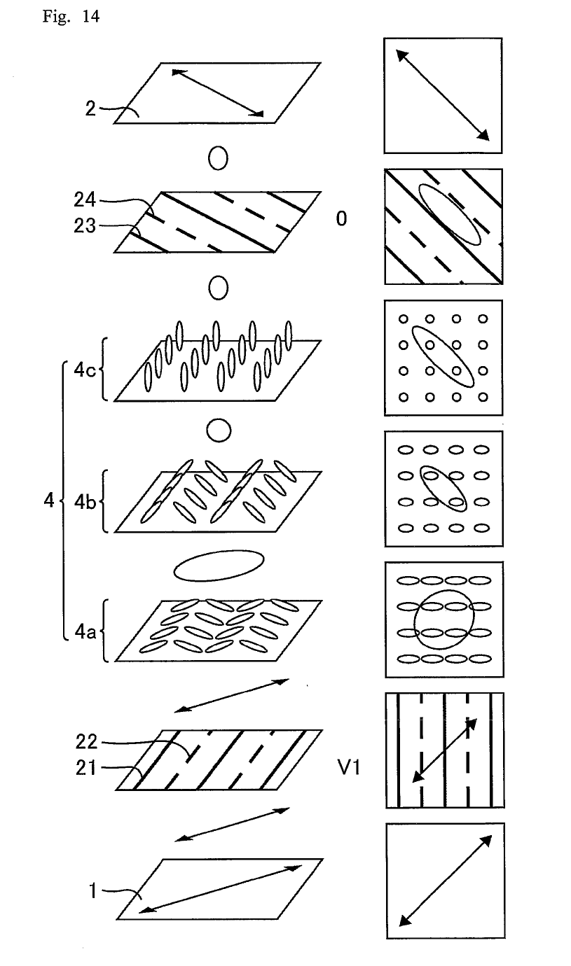

FIG. 13 and FIG. 14 are schematic diagrams illustrating the configuration of each member of the liquid crystal display device of Embodiment 1 while light passes through the respective members, as well as respective stages showing the polarizing state of the transmitted light. FIG. 13 illustrates a state at a time of a black display, and FIG. 14 illustrates a state at a time of a gradation display. The left columns in FIG. 13 and FIG. 14 represent perspective views, and the right columns represent plan views when a display region is viewed from a normal line direction. The respective views show constituent members of the liquid crystal display device at respective stages, and the respective double-headed arrows show the vibration direction of light at the respective stages.

First, with respect to FIG. 13, the order in which light is transmitted is described from the bottom side, that is, from the incidence side of light from the backlight. FIG. 13 shows a state in which a voltage of V2 is applied into the liquid crystal layer by means of the comb-shaped electrode pair on the opposed substrate side. In this case, although, for convenience, the potential of the comb-shaped electrode pair on the TFT substrate side is assumed to be 0V and not V1, as long as the condition V2>V1 is satisfied, the same tendency is shown. Further, the potential of a comb-shaped electrode pair on the TFT substrate side in Embodiment 2 that is described later is 0V.

When light from the backlight is incident within the liquid crystal display panel, first, only light in the transmission axis direction of the polarizer is transmitted by the polarizer (first polarizer) 1 on the TFT substrate side.

Subsequently, the light passes through the comb-shaped electrodes 21 and 22 on the TFT substrate side and liquid crystal molecules (lower layer liquid crystals) 4a adjacent to the TFT substrate. However, since a voltage generated by the comb-shaped electrodes 21 and 22 of the TFT substrate is 0V, the lower layer liquid crystals 4a do not receive the influence of an electric field and remain vertically aligned, and the light passes through while retaining the vibration direction thereof in the same direction.

Next, the light passes through liquid crystal molecules (center liquid crystals) 4b located in the center region of the liquid crystal layer. At this time, the center liquid crystals 4b receive the influence of the voltage V2 generated by the comb-shaped electrodes 23 and 24 on the opposed substrate side, and tilt in a diagonal direction relative to the substrate surface. However, the orientation of the long axis of the liquid crystal molecules when viewed from a normal line direction relative to the substrate surface is orthogonal to the orientation of the long axis of the comb tooth portion of the comb-shaped electrodes 23 and 24 on the opposed substrate side, that is, is a parallel direction to the vibration direction of the light. Therefore, light that is transmitted through the center liquid crystals 4b does not receive the influence of birefringence of the liquid crystal molecules, and passes through while retaining the same vibration direction.

Subsequently, the light passes through liquid crystal molecules (upper layer liquid crystals) 4c that are adjacent to the opposed substrate, and comb-shaped electrodes 23 and 24 on the opposed substrate side. Although the size of the tilt of the upper layer liquid crystals 4c is different to that of the center liquid crystals 4b, because the upper layer liquid crystals 4c receive the influence of the voltage V2 that is generated by the comb-shaped electrodes 23 and 24 on the opposed substrate side, the tendency is the same as for the center liquid crystals 4b, and the orientation of the long axis of the liquid crystal molecule when viewed from a normal line direction relative to the substrate surface is a parallel direction to the vibration direction of the light. Consequently, light that is transmitted through the upper layer liquid crystals 4c does not receive the influence of birefringence of the liquid crystal molecules and passes through while retaining the same vibration direction.

Next, the light arrives at the polarizer (second polarizer) 2 on the opposed substrate side. Since the orientation of the transmission axis of the second polarizer 2 is orthogonal to the direction of vibration of the light that has passed through the liquid crystal layer 4, the light is blocked by the second polarizer 2.

Thus, in a state in which a voltage is being applied into the liquid crystal layer by means of the comb-shaped electrodes 23 and 24 on the opposed substrate side, the display is a black display (an off state).

Next, with respect to FIG. 14, the order in which light is transmitted is described from the bottom side, that is, from the incidence side of light from the backlight. FIG. 14 shows a state in which a voltage of V1 is applied into the liquid crystal layer 4 by means of the comb-shaped electrodes 21 and 22 on the TFT substrate side.

When light from the backlight is incident within the liquid crystal display panel, first, only light in the transmission axis direction of the polarizer is transmitted by the polarizer (first polarizer) 1 on the TFT substrate side.

Next, the light passes through the comb-shaped electrodes 21 and 22 on the TFT substrate side and the lower layer liquid crystals 4a. At this time, since the voltage V1 is being applied into the liquid crystal layer 4 by means of the comb-shaped electrodes 21 and 22 of the TFT substrate, the lower layer liquid crystals 4a tilt in an oblique direction relative to the substrate surface, and the orientation of the long axis of the lower layer liquid crystal 4a when the substrate surface is viewed from the normal line direction is orthogonal to the long axis direction of the comb tooth portion of the comb-shaped electrodes 21 and 22 on the TFT substrate side. That is, the long axis direction of the liquid crystal molecule when the substrate surface is viewed from the normal line direction and the vibration direction of the light form an angle of substantially 45°, and light that has passed through the lower layer liquid crystals 4a forms elliptically polarized light having a long axis in a direction that forms an angle of substantially 45° with the long axis direction of the liquid crystal molecule when the substrate surface is viewed from the normal line direction.

Subsequently, the light passes through the center liquid crystals 4b. At this time, since the center liquid crystals 4b also receive the influence of the voltage V1 generated by the comb-shaped electrodes 21 and 22 on the TFT substrate side, the orientation of the long axis of the liquid crystal molecule when viewed from a normal line direction with respect to the substrate surface is orthogonal to the long axis direction of the comb tooth portion of the comb-shaped electrodes 21 and 22 on the TFT substrate side. However, since the tilt angle of the center liquid crystals 4b with respect to the substrate surface is greater than the tilt angle of the lower layer liquid crystals 4a with respect to the substrate surface, light that is transmitted through the center liquid crystals 4b is converted to elliptically polarized light in which the orientation of the long axis is rotated by 90°.

Next, the light passes through the upper layer liquid crystals 4c, and the comb-shaped electrodes 23 and 24 on the opposed substrate side. Since the voltage generated by the comb-shaped electrodes 23 and 24 on the opposed substrate side is 0V, the influence of an electric field on the upper layer liquid crystals 4c is small and the upper layer liquid crystals 4c are close to a state of vertical alignment. As a result of this alignment, light transmitted through the upper layer liquid crystals 4c is converted from elliptically polarized light to substantially linearly polarized light while retaining the long axis orientation of the light as it is. More specifically, the light is converted to light having a vibration direction in a direction that forms an angle of 90° with respect to the vibration direction of the light when the light was incident.

Subsequently, the light arrives at the polarizer (second polarizer) 2 on the opposed substrate side. Since the direction of the transmission axis of the second polarizer 2 is parallel to the direction of vibration of the light that has passed through the liquid crystal layer 4, the light can pass through the second polarizer 2.

Thus, in a state in which a voltage is being applied into the liquid crystal layer 4 by the comb-shaped electrodes 21 and 22 on the TFT substrate side, the display is a gradation display (in an “on” state), and a transmittance that is in accordance with the voltage can be obtained.

According to the liquid crystal display device of Embodiment 1, switching between off and on states is performed in this manner at separate timings and using separate pairs of comb-shaped electrodes. Further, for all gradation displays, a black display is obtained with a fast response by a rise effect that is caused by the large voltage V2 that is applied to the comb-shaped electrode pair on the opposed substrate side when selecting the previous row (n−x^{th} row), and a gradation display is obtained with a fast response by a fall effect that is caused by the voltage V1 that is applied to the comb-shaped electrode pair on the TFT substrate side when selecting the relevant row (n^{th} row). Hence, dramatically improved response characteristics can be obtained for the overall display device.

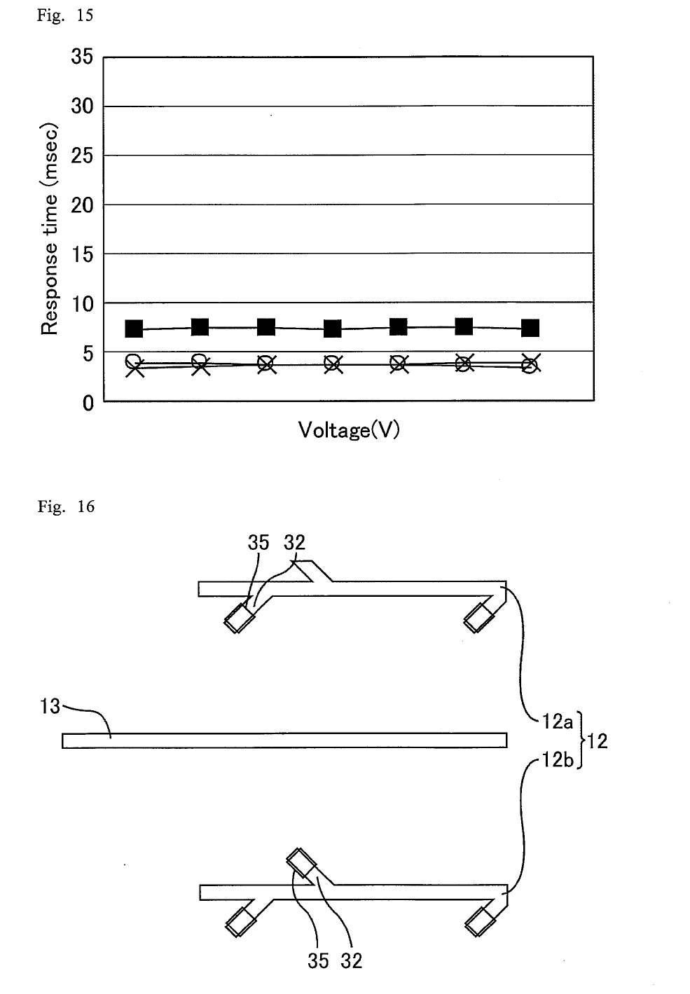

FIG. 15 is a graph showing response characteristics of the liquid crystal display device of Embodiment 1. As shown in FIG. 15, with respect to a response from an off state to an on state that is represented by the symbol “o” in FIG. 15 and the response from an on state to an off state that is represented by the symbol “x” in FIG. 15, respectively, a fast response speed can be obtained at all voltages. As a result, the overall response speed that is represented by the symbol “▪” in FIG. 15 is significantly improved in comparison to the case illustrated in Figure D. In this connection, the response characteristics shown in FIG. 15 were measured using an LCD evaluation system (LCD-5200) manufactured by Otsuka Electronics Co. Ltd.

Note that, in the liquid crystal display device of Embodiment 1, even in a case in which light is incident from the opposite direction to that described above, the light will exhibit similar changes, and hence the tendency for light to be transmitted or blocked by a polarizer will not change. Accordingly, in Embodiment 1, as long as the arrangement relationship between each comb-shaped electrode pair and each polarizer does not change, the incident direction of light may be from the opposed substrate side. Further, in Embodiment 1, the second comb-shaped electrode pair may be disposed on the TFT substrate side, and the first comb-shaped electrode pair may be disposed on the opposed substrate side. Furthermore, the voltage V2 that is applied to the comb-shaped electrode pair on the opposed substrate side need not necessarily be a voltage that is applied through the gate wiring.

According to the present embodiment, an example has been described in which the orientations of the comb tooth portions of the TFT common electrode and the TFT pixel electrode are at an angle of 45° with respect to the row direction, respectively, and the orientations of the comb tooth portions of the opposed common electrode and the opposed pixel electrode are orthogonal to the row direction, respectively. However, as long as the positional relationship with the polarizers is the same, the orientations of the comb tooth portions of the TFT common electrode and the TFT pixel electrode may be orthogonal to the row direction, respectively, and the orientations of the comb tooth portions of the opposed common electrode and the opposed pixel electrode may be arranged so as to be at an angle of 45° with respect to the row direction, respectively. In this case, the transmission axes of the first and second polarizers are in directions that are at an angle of 45° with respect to the row direction.

### Embodiment 2

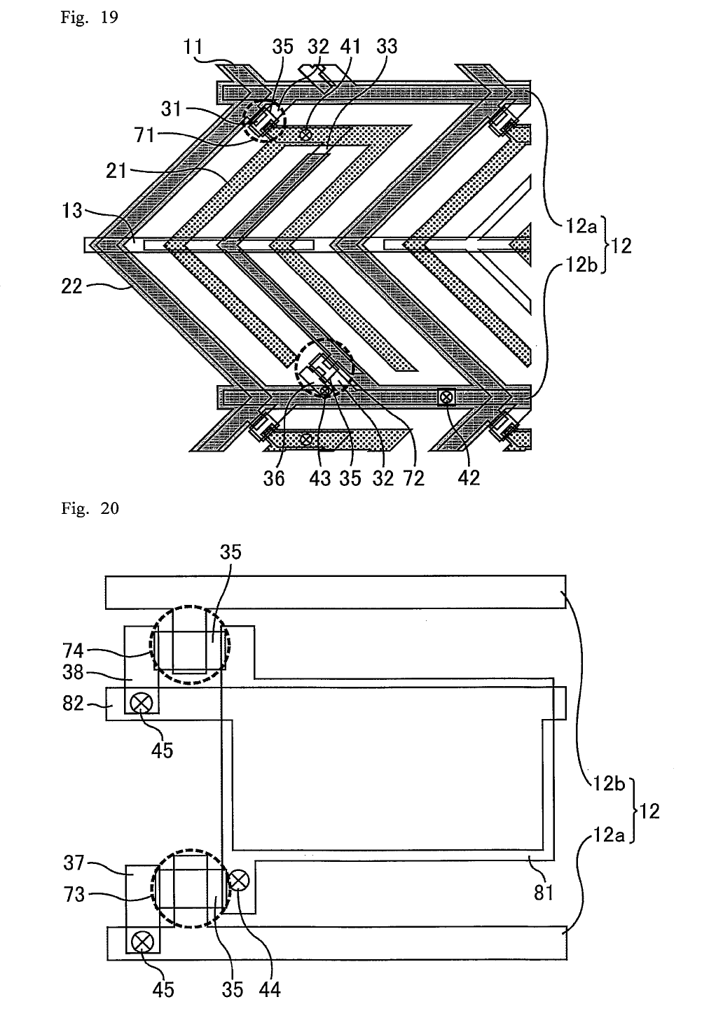

A liquid crystal display device according to Embodiment 2 is the same as the liquid crystal display device according to Embodiment 1 except that the liquid crystal display device according to Embodiment 2 includes a mechanism (reset electrode) for resetting a voltage that is retained in the pixel electrode on the TFT substrate side to 0V. FIG. 19 is a planar schematic view of a picture element unit of a TFT substrate included in the liquid crystal display device according to Embodiment 2.

Hereunder, the configuration according to Embodiment 2 is described in detail by describing each manufacturing stage of the liquid crystal display device using FIGS. 16 to 19. FIGS. 16 to 19 are planar schematic views illustrating respective manufacturing stages of the liquid crystal display device of Embodiment 2.

First, as shown in FIG. 16, as the gate wiring 12, a plurality of wirings are provided so that the respective wirings extend rectilinearly in the row direction and are parallel with each other. In addition, as the Cs wiring 13 for forming a storage capacitance, wiring is provided so as to extend rectilinearly in the row direction and in parallel with the gate wiring 12 at a position that is located at a gap between gate wirings 12a and 12b. Further, wiring that serves as the gate electrode 32 of the TFT is extended from a portion of the gate wirings 12a and 12b, respectively. At this time, unlike the configuration of Embodiment 1, extension areas that serve as the gate electrodes 32 are provided on both sides of the gate wiring 12 to thereby form two gate electrodes in picture element units. More specifically, according to Embodiment 2, for each picture element, a first TFT controlled by the gate wiring 12a of the relevant row and a second TFT controlled by the gate wiring 12b of an adjacent row are formed. Further, semiconductor layers 35 are provided through a gate insulator at positions that overlap with the respective gate electrodes 32.

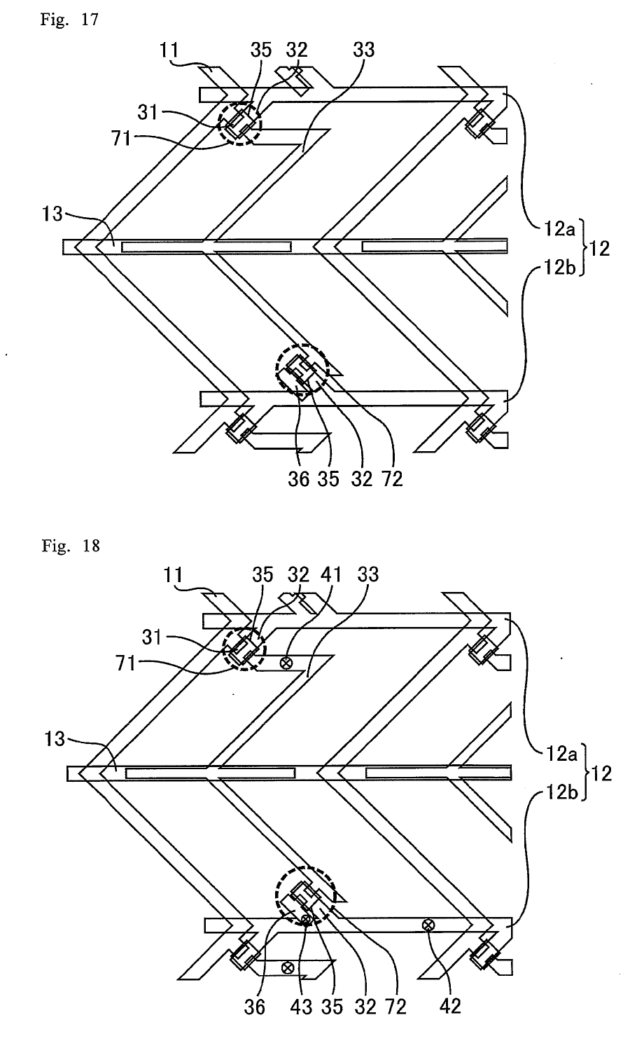

Next, as shown in FIG. 17, as the source wiring 11, a plurality of wirings are provided so that the respective wirings extend in the column direction, and are parallel with each other in a semi-inverted V shape in picture element units. Thus, each source wiring 11 has a zigzag shape when viewed with respect to the entire display region. Further, each source wiring 11 is provided so as to intersect with the gate wiring 12 and the Cs wiring 13 through the insulator. In addition, a reset electrode 36 is provided in a region adjoining the gate electrode 32 that extends from the gate wiring 12b of an adjacent row that constitutes a second TFT.

When forming the drain electrode 33 of the TFT, the drain electrode 33 is extended as far as the center of the picture element. A Cs electrode is provided by further extending the drain lead-out wiring 13 to a position that overlaps with the Cs wiring through the insulator. Thus, a storage capacitance of a constant amount is formed between the Cs wiring 13 and the Cs electrode 33, and an image signal is stably retained.

Further, in Embodiment 2, the drain electrode 33 is extended as far as the vicinity of the gate electrode 32 that constitutes the second TFT, and is connected with the reset electrode 36 through the semiconductor layer 35.

Next, as shown in FIG. 18, a contact portion (first contact portion 41) is provided at one portion of the drain electrode 33, and a contact portion (third contact portion 43) is provided at one portion of the reset electrode 36.

The first contact portion 41 is an area provided in the insulator that is formed between the drain electrode 33 and the TFT pixel electrode 21 to connect the drain electrode 33 and the TFT pixel electrode 21. Thus, the TFT 71 is connected to the TFT pixel electrode 21 through the drain electrode 33 and the first contact portion 41, and an image signal from the source wiring 11 is supplied at a predetermined timing to the TFT pixel electrode 21 through the TFT 71 that has been placed in an “on” state for a certain time period by input of a scanning signal.

The third contact portion 43 is provided to connect the TFT common electrode 22 and the reset electrode 36. As a result, the TFT common electrode 22 and the drain electrode 33 are connected through the second TFT, and by switching a gate voltage that is applied to data wiring of an adjacent row, the gate voltage of the adjacent row is applied to the second TFT, and the TFT pixel electrode 21 and the TFT common electrode 22 become equipotential and are reset.

A contact portion (second contact portion) 42 is also provided at a portion of the gate wiring. The second contact portion 42 is an area that is provided for connecting the gate wiring 12 on the TFT substrate side and the pixel electrode on the opposed substrate side. Thus, a scanning signal that is supplied through the gate wiring 12 on the TFT substrate side is also supplied to the pixel electrode on the opposed substrate side through the second contact portion 42.

Next, the TFT pixel electrode 21 and the TFT common electrode 22 are provided as shown in FIG. 19.

The TFT pixel electrode 21 is provided so as to have a trunk portion and a plurality of comb tooth portions that protrude planarly from a part of the trunk portion.

The TFT common electrode 22 is formed on a different layer to the source wiring 11 and the gate wiring 12 through the insulator, and is provided so as to overlap with the source wiring 11 and the gate wiring 12, respectively. The area of the TFT common electrode 22 that overlaps with the source wiring 11 and the gate wiring 12 is a trunk portion 22a. The trunk portion 22a of the TFT common electrode constitutes a matrix shape that corresponds to a combined shape of the source wiring 11 and the gate wiring 12 as viewed in terms of the overall display region. The TFT common electrode 22 is provided such that comb tooth portions 21b protrude planarly from a part of the trunk portion 21a.

The comb tooth portions of the TFT pixel electrode 21 and the comb tooth portions of the TFT common electrode 22 each form a semi-inverted V shape in picture element units, and are provided so as to be parallel with each other. Further, the comb tooth portions of the TFT pixel electrode 21 and the comb tooth portions of the TFT common electrode 22 are disposed so as to be alternately disposed with each other with a certain space therebetween.

Thus, the comb tooth portions of the TFT pixel electrode 21 and the comb tooth portions of the TFT common electrode 22 are provided so as to be also parallel with the source wiring 11. Accordingly, the comb tooth portions of the TFT pixel electrode 21 are also in a parallel relation with a part of the trunk portion of the TFT common electrode 22.

The design profile such as the shape, size, and material of the TFT pixel electrode 21 and the TFT common electrode 22 as well as the opposed pixel electrode 23 and the opposed common electrode 24 are the same as in Embodiment 1.

Thus, a TFT substrate having a basic configuration as shown in FIG. 19 is obtained. In this connection, similarly to Embodiment 1, Embodiment 2 can also be made in the forms shown in Modification Example 1 and Modification Example 2, and portions that are rectilinear in a diagonal direction relative to the extending direction of the gate wiring 12 may also be used for the comb tooth portions of the TFT pixel electrode 21 and the comb tooth portions of the TFT common electrode 22. In this case, the source wiring 11 needs to be extended in a diagonal direction relative to the extending direction of the gate wiring 12 in conformity with the shape of the comb tooth portions of the TFT pixel electrode 21 and the comb tooth portions of the TFT common electrode 22.

FIG. 20 is a planar schematic view of a storage capacitance formation portion that is provided outside a display portion of the opposed substrate included in the liquid crystal display device of Embodiment 2. The opposed substrate according to Embodiment 2 has a configuration as shown in FIG. 20, other than the opposed pixel electrode and the opposed common electrode. The respective structures of the opposed pixel electrode and the opposed common electrode are the same as the structures shown in FIG. 8 according to Embodiment 1.

As shown in FIG. 20, the opposed pixel electrode 23 (not shown) is connected to an opposed Cs electrode 81 through a contact portion (fourth contact portion) 44. The opposed pixel electrode 23 (not shown) and the opposed Cs electrode 81 are provided on different layers to each other through an insulator. The opposed Cs electrode 81 is disposed so as to overlap with Cs wiring 82 that is provided through the insulator, and form a storage capacitance of a constant amount between the opposed Cs electrode 81 and the Cs wiring 82. The Cs wiring 82 is formed with a wide width in a region that overlaps with the opposed Cs electrode 81.

The opposed Cs electrode 81 is connected to the gate wiring 12a through a third TFT 73. More specifically, the gate wiring 12a is connected to a gate pad 37 through a contact portion (fifth contact portion) 45, and the gate pad 37 and the opposed Cs electrode 81 are connected to each other through the semiconductor layer 35 of the third TFT 73.

According to this configuration, when a gate voltage is transmitted through the gate wiring 12a and is applied to the gate electrode of the third TFT 73, by a switching operation of the third TFT 73, the gate voltage flows into the opposed Cs electrode 81 and thus a scanning signal can be supplied to the opposed pixel electrode.

The opposed Cs electrode 81 is also connected to the Cs wiring 82 through a fourth TFT 74. More specifically, the Cs wiring 82 is connected to a Cs pad 38 that has been lead out from the Cs wiring 82 through a contact portion (fifth contact portion) 45, and the Cs pad 38 and the opposed Cs electrode 81 are connected to each other through the semiconductor layer 35 of the fourth TFT 74.

According to this configuration, when the gate voltage is transmitted through the gate wiring 12b and applied to the gate electrode of the fourth TFT 74, by a switching operation of the fourth TFT 74, a pixel voltage that has been retained flows into the Cs wiring 82, and the opposed pixel electrode and the opposed Cs electrode 81 become equipotential and are reset. That is, the Cs pad 38 also functions as a reset electrode.

The gate wiring of the TFT substrate or gate wiring that is formed separately and independently on the opposed substrate may be utilized as gate wiring that applies a gate voltage to the comb-shaped electrode pair of the opposed substrate. Further, a TFT may be separately formed on the opposed substrate. When utilizing the gate wiring of the TFT substrate, it is necessary to route a wiring thorough a columnar spacer or the like that is provided between the TFT substrate and the opposed substrate at a position that is outside a display region of the TFT substrate. When drawing in the gate wiring using a columnar spacer, since the liquid crystal molecules may be disturbed around the columnar spacer, it is preferable to provide a light shielding portion at a region that overlaps with the columnar spacer.

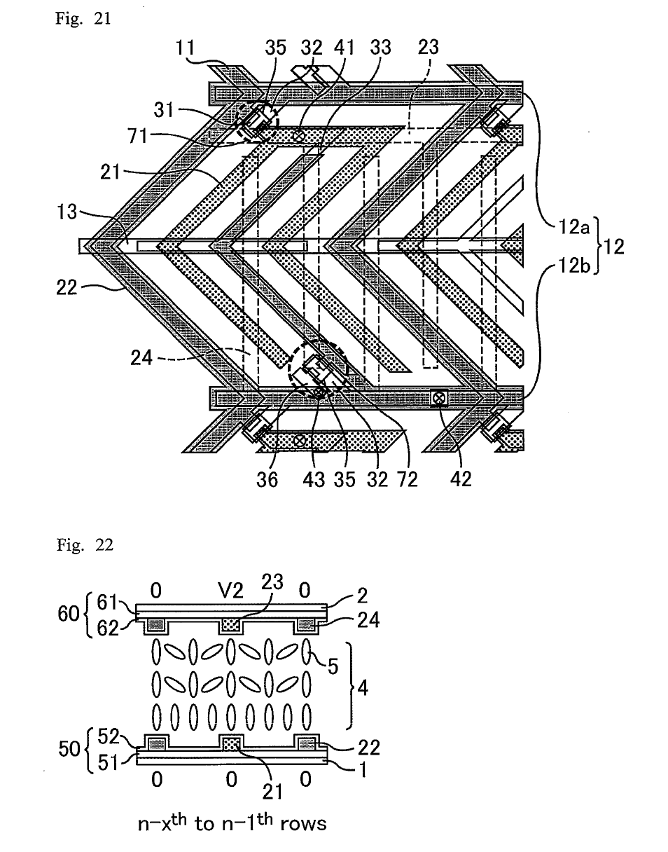

FIG. 21 is a planar schematic view of a picture element unit when the TFT substrate and the opposed substrate included in the liquid crystal display device of Embodiment 2 are superimposed with respect to each other. Portions indicated by solid lines in FIG. 21 represent constituent members on the TFT substrate side, and portions indicated by broken lines represent constituent members on the opposed substrate side. As shown in FIG. 21, when the TFT substrate and the opposed substrate are superimposed, the long axis of the comb tooth portion of the comb-shaped electrodes 21 and 22 constituting the first comb-shaped electrode pair and the long axis of the comb tooth portion of the comb-shaped electrodes 23 and 24 constituting the second comb-shaped electrode pair form an angle of substantially 45°.

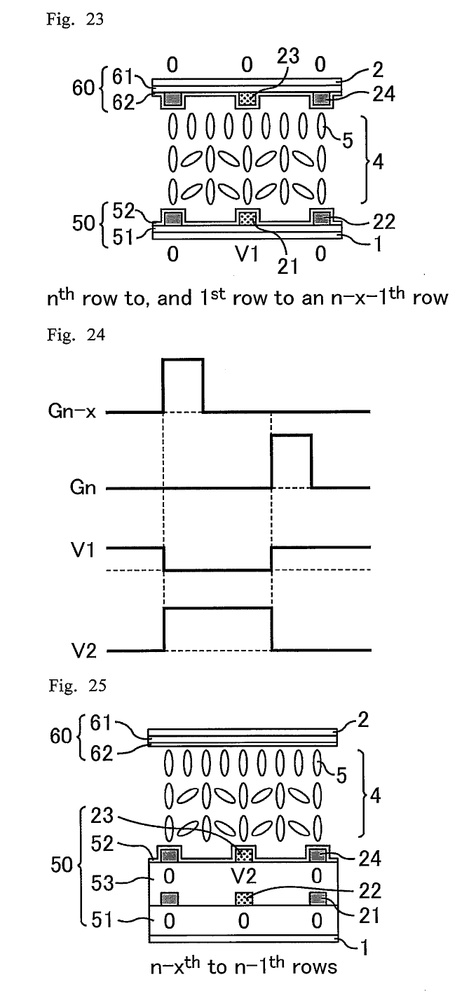

The configuration and driving method of the liquid crystal display device according to Embodiment 2 will now be described in detail. FIGS. 22 and 23 are cross-sectional schematic diagrams of the liquid crystal display device according to Embodiment 2, which, in particular, illustrate the behavior of liquid crystal molecules in detail. FIG. 22 illustrates the behavior of liquid crystal molecules in a state in which a voltage is applied to a pixel electrode connected to gate wiring of an n−x^{th} to n−1^{th} row, when gate wiring of a given n^{th} row is taken as a basis. FIG. 23 illustrates the behavior of liquid crystal molecules in a state in which a voltage is applied to a pixel electrode connected to gate wiring of an n^{th} row to, and 1^{st} row to an n−x−1^{th} row.

As shown in FIGS. 22 and 23, the liquid crystal display device of Embodiment 2 includes a liquid crystal display panel that has a pair of substrates constituted by a TFT substrate 50 and an opposed substrate 60, and a liquid crystal layer 4 between the TFT substrate 50 and the opposed substrate 60.

The design profile such as the shape, size, and material of each member of the TFT substrate 11 and the opposed substrate are the same as in Embodiment 1.

As shown in FIG. 22, a picture element that is controlled with gate wiring of the n−x^{th} to n−1^{th} rows is in a state in which an arch-shaped transverse electric field is formed between comb tooth portions of the comb-shaped electrodes 23 and 24 formed on the opposed substrate 60 side, and a change occurs in the alignment properties of the liquid crystal molecules 5 along the arch-shaped transverse electric field. A group of the liquid crystal molecules 5 that receive the influence of the electric field in this manner exhibit an overall bent alignment in the lateral direction that is symmetrical around an intermediate region between the comb tooth portions.

As shown in FIG. 23, a picture element that is controlled with the gate wiring of the n^{th} row to, and 1^{st} row to the n−x−1^{th} row is in a state in which an arch-shaped transverse electric field is formed between comb tooth portions of the comb-shaped electrodes 21 and 22 formed on the TFT substrate side, and a change occurs in the alignment properties of the liquid crystal molecules 5 along the arch-shaped transverse electric field. A group of the liquid crystal molecules 5 that receive the influence of the electric field in this manner exhibit an overall bent alignment in the lateral direction that is symmetrical around an intermediate region between the comb tooth portions.

However, as shown in FIG. 22 and FIG. 23, since there is no electric field at the liquid crystal molecules 5 positioned at the ends of the arch-shaped transverse electric field, that is, the liquid crystal molecules 5 positioned directly above the pixel electrodes 21 and 23 or the common electrodes 22 and 24, the liquid crystal molecules 5 in question remain aligned in the vertical direction relative to the surfaces of the substrates 50 and 60. Further, the liquid crystal molecules 5 that are positioned in an intermediate region between comb tooth portions and that are at a furthest distance from the comb teeth within regions between the comb tooth portions also remain aligned in the vertical direction relative to the surfaces of the pair of substrates 50 and 60.

As shown in FIG. 22 and FIG. 23, according to Embodiment 2, the voltage size and timing differs between a voltage that is applied to the comb-shaped electrode pair on the TFT substrate 50 side and a voltage that is applied to the comb-shaped electrode pair on the opposed substrate 60 side. By varying the size and timing of the voltages in this manner, the respective combinations of comb-shaped electrode pairs can separately control the alignment properties of the liquid crystal molecules.

FIG. 24 is a timing chart that shows the sizes and timings of voltages that are applied to the liquid crystal display device of Embodiment 2. The reference characters in FIG. 24 and the meaning of the reference characters are the same as in FIG. 12.

When a gate voltage is applied to the gate wiring of the n−x^{th} to n−1^{th} rows shown in FIG. 22, unlike the case of Embodiment 1, a state is entered in which a potential difference between the comb tooth portions of the comb-shaped electrodes 21 and 22 on the TFT substrate 50 side is 0V. Therefore, according to Embodiment 2, when applying a gate voltage to the gate wiring of the n−x^{th} row, application of the gate voltage is performed while the inside of the liquid crystal layer is in a state in which a voltage is not applied thereto, and thus high response characteristics can be obtained.

The liquid crystal molecules in the n−x^{th} row to which the voltage V2 is applied align in a direction that is orthogonal to the long axis of the comb-shaped electrode pair. Hence, light that passes through the liquid crystal layer 4 in this state is polarized to polarized light having an axis in a direction that is orthogonal to the transmission axis of the polarizer (second polarizer) 2 on the opposed substrate 60 side. As a result, the light is blocked by the second polarizer and the display enters an “off” (black display) state.

The response to enter a black display state in this case is performed by means of an alignment change in which a high voltage is applied to liquid crystal molecules that were originally aligned in a direction at an angle of 45 degrees relative to the direction of the transmission axis of the polarizer to thereby cause the liquid crystal molecules to rotate in the horizontal or vertical direction relative to the direction of the transmission axis of the polarizer. The aforementioned response compares favorably with a response performed in the conventional manner by means of an alignment change that causes liquid crystal molecules that were originally aligned in a horizontal direction relative to a substrate surface to fall in the vertical direction. Further, since a response from a black display state to a gradation display state uses fall characteristics that cause liquid crystal molecules that were aligned in the direction of the transmission axis of the polarizer by means of a high electric field to rotate while applying a lower voltage thereto, response characteristics of a change to a gradation display state are improved.

In this connection, according to Embodiment 2, the gate voltage V2 of the gate wiring of the TFT substrate 50 is used as a voltage that is applied to the opposed pixel electrode 23, and the voltage is a sufficient size with respect to the source voltage V1 that is applied to the TFT pixel electrode.

As shown in FIG. 23, the gate wiring of the nth row to, and 1^{st} row to the n−x−1^{th} row is connected to the TFT pixel electrode 21, and thus the voltage V1 is applied into the liquid crystal layer by the comb-shaped electrode pair on the TFT substrate 50 side.

The liquid crystal molecules 5 of the n^{th} row to, and 1^{st} row to the n−x−1^{th} row to which the voltage V1 is applied exhibit an alignment along an arch-shaped transverse electric field formed between the comb-shaped electrode pair on the TFT substrate 50 side. More specifically, since the liquid crystal molecules 5 align in a direction that is orthogonal to the long axis of the comb-shaped electrode pair, light that passes through the liquid crystal layer in this state is polarized to polarized light having an axis in a direction that is orthogonal to the transmission axis of the polarizer (first polarizer) 1 on the TFT substrate 50 side. As a result, light that has passed through the liquid crystal layer 4 is transmitted through the second polarizer 2 and the display enters an “on” (gradation display) state.

The details of the behavior of liquid crystal molecules and changes in the polarizing state of light in the liquid crystal layer of the liquid crystal display device of Embodiment 2 that is described above are the same as in Embodiment 1, and are as illustrated in FIG. 13 and FIG. 14.

According to the liquid crystal display device of Embodiment 2, switching between off and on states is performed in this manner at separate timings and with separate pairs of comb-shaped electrodes. Further, for all gradation displays, a black display is obtained with a fast response by a rise effect that is caused by the large voltage V2 that is applied to the comb-shaped electrode pair on the opposed substrate side when selecting the previous row (n−x^{th} row), and a gradation display is obtained with a fast response by a fall effect that is caused by the voltage V1 that is applied to the comb-shaped electrode pair on the TFT substrate side when selecting the relevant row (n^{th} row). Hence, dramatically improved response characteristics can be obtained for the overall display device.

Further, since the liquid crystal display device according to Embodiment 2 is designed so that a potential of either V1 or V2 is always retained in the liquid crystal layer by resetting, through a reset electrode, the opposed pixel electrode when the voltage V1 is applied to the comb-shaped electrode pair of the TFT substrate or the TFT pixel electrode when the voltage V2 is applied to the comb-shaped electrode pair of the opposed substrate, the effect of a fast response can be obtained more stably. Further, it can be said that utilizing the timings for applying gate voltages of each row to set states in which the aforementioned voltages are retained is also a feature of the present embodiment.

Note that, in the liquid crystal display device of Embodiment 2, even in a case in which light is incident from the opposite direction to that described above, the light will exhibit similar changes, and hence the tendency for light to be transmitted or blocked by a polarizer will not change. Accordingly, in Embodiment 2, as long as the arrangement relationship between each comb-shaped electrode pair and each polarizer does not change, the incident direction of light may be from the opposed substrate side. Further, in Embodiment 1, the second comb-shaped electrode pair may be disposed on the TFT substrate side, and the first comb-shaped electrode pair may be disposed on the opposed substrate side. Furthermore, the voltage V2 that is applied to the comb-shaped electrode pair on the opposed substrate side need not necessarily be a voltage that is applied through the gate wiring.

### Embodiment 3

A liquid crystal display device of Embodiment 3 is the same as the liquid crystal display device of Embodiment 2, except that locations at which the two sets of comb-shaped electrode pairs are disposed are different from the liquid crystal display device of Embodiment 2. More specifically, according to the liquid crystal display device of Embodiment 3, a comb-shaped electrode pair (hereunder, referred to as “TFT comb-shaped electrode pair”) constituted by a TFT pixel electrode and a TFT common electrode, and a comb-shaped electrode pair (hereunder, referred to as “opposed comb-shaped electrode pair”) constituted by an opposed pixel electrode and an opposed common electrode are disposed on a TFT substrate. In other words, relative to the liquid crystal display device according to Embodiment 2, in the liquid crystal display device according to Embodiment 3 the opposed comb-shaped electrode pair are moved to the TFT substrate side.

According to Embodiment 3, the TFT comb-shaped electrode pair and the opposed comb-shaped electrode pair are disposed on respectively different layers through an insulator having translucency inside the same TFT substrate. Examples of the material of the insulator include an organic insulator such as acryl and polyimide and the like.

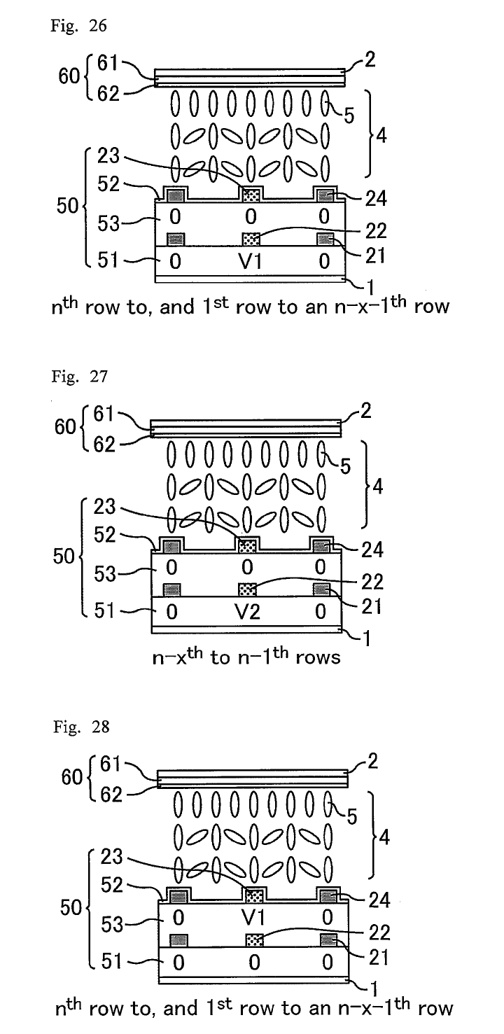

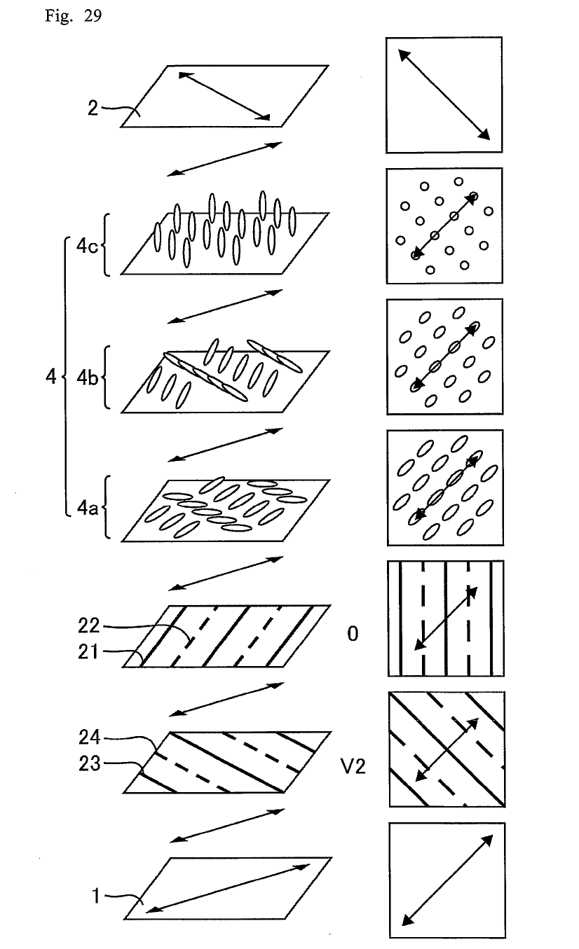

The configuration and driving method of the liquid crystal display device according to Embodiment 3 will now be described in detail. FIGS. 25 to 28 are cross-sectional schematic diagrams of the liquid crystal display device according to Embodiment 3, which, in particular, illustrate the behavior of liquid crystal molecules in detail. FIGS. 25 and 26 illustrate a form in which the opposed comb-shaped electrode pair is disposed between the TFT comb-shaped electrode pair and the liquid crystal layer. FIGS. 27 and 28 illustrate a form in which the TFT comb-shaped electrode pair is disposed between the opposed comb-shaped electrode pair and the liquid crystal layer. FIG. 25 and FIG. 27 illustrate the behavior of liquid crystal molecules in a state in which a voltage is applied to a pixel electrode connected to gate wiring of an n−x^{th} to n−1^{th} row, and FIG. 26 and FIG. 28 illustrate the behavior of liquid crystal molecules in a state in which a voltage is applied to a pixel electrode connected to gate wiring of an n^{th} row to, and 1^{st} row to an n−x−1^{th} row, when gate wiring of a given n^{th} row is taken as a basis.

As shown in FIGS. 25 to 28, the liquid crystal display device according to Embodiment 3 includes a liquid crystal display panel that has a pair of substrates constituted by the TFT substrate 50 and the opposed substrate 60, and the liquid crystal layer 4 between the TFT substrate 50 and the opposed substrate 60.

More specifically, as shown in FIGS. 25 and 26, the TFT substrate 50 includes a transparent substrate 51 having translucency that is made of glass or resin or the like as a main constituent, and has the TFT comb-shaped electrodes 21 and 22 on the transparent substrate 51, and also has the opposed comb-shaped electrodes 23 and 24 through an insulator 53 having translucency.

Further, as shown in FIGS. 27 and 28, the TFT substrate 50 includes the transparent substrate 51 having translucency that is made of glass or resin or the like as a main constituent, and has the opposed comb-shaped electrodes 23 and 24 on the transparent substrate 51, and also has the TFT comb-shaped electrodes 21 and 22 through the insulator 53 having translucency.

The comb teeth of each of the pixel electrode 21 and the common electrode 22, respectively, that constitute the TFT comb-shaped electrode pair (first comb-shaped electrode pair) are alternately disposed with a certain space therebetween. Further, the comb teeth of each of the pixel electrode 23 and the common electrode 24 that constitute the opposed comb-shaped electrode pair (second comb-shaped electrode pair) are alternately disposed with a certain space therebetween.

The design profile such as the shape, size, and material of each member of the TFT substrate 50 and the opposed substrate 60 are the same as in Embodiment 1, and the thickness of the insulator provided between the TFT comb-shaped electrode pair and the opposed comb-shaped electrode pair is preferably between 100 and 1000 nm.

As shown in FIGS. 25 and 27, a picture element that is controlled with gate wiring of the n−x^{th} to n−1^{th} rows is in a state in which an arch-shaped transverse electric field is formed between comb tooth portions of the opposed comb-shaped electrodes 23 and 24, and a change occurs in the alignment properties of the liquid crystal molecules 5 along the arch-shaped transverse electric field. A group of the liquid crystal molecules 5 that receive the influence of the electric field in this manner exhibits an overall bent alignment in the lateral direction that is symmetrical around an intermediate region between the comb tooth portions.

As shown in FIGS. 26 and 28, a picture element that is controlled with gate wiring of the n^{th} row to, and 1^{st} row to the n−x−1^{th} row is in a state in which an arch-shaped transverse electric field is formed between the TFT comb-shaped electrodes 21 and 22, and a change occurs in the alignment properties of the liquid crystal molecules 5 along the arch-shaped transverse electric field. A group of the liquid crystal molecules 5 that receive the influence of the electric field in this manner exhibits an overall bent alignment in the lateral direction that is symmetrical around an intermediate region between the comb tooth portions.

However, as shown in FIGS. 25 to 28, since there is no electric field at the liquid crystal molecules 5 positioned at the ends of the arch-shaped transverse electric field, that is, the liquid crystal molecules 5 positioned directly above the pixel electrodes 21 and 23 or the common electrodes 22 and 24, the liquid crystal molecules 5 in question remain aligned in the vertical direction relative to the surfaces of the substrates 50 and 60. Further, the liquid crystal molecules 5 that are positioned in an intermediate region between comb tooth portions and that are at a furthest distance from the comb teeth within regions between the comb tooth portions also remain aligned in the vertical direction relative to the surfaces of the pair of substrates 50 and 60.

As shown in FIGS. 25 to 28, according to Embodiment 3, the voltage size and timing differs between a voltage that is applied to the TFT comb-shaped electrode pair and a voltage that is applied to the opposed comb-shaped electrode pair. By varying the size and timing of the voltages in this manner, the respective combinations of comb-shaped electrode pairs can separately control the alignment properties of the liquid crystal molecules.

When a gate voltage is applied to the gate wiring of the n−x^{th} to n−1^{th} rows that are shown in FIG. 25 and FIG. 27, unlike the case of Embodiment 1, a state is entered in which a potential difference between the comb tooth portions of the TFT comb-shaped electrodes 21 and 22 is 0V. Therefore, according to Embodiment 3, when applying a gate voltage to the gate wiring of the n−x^{th} row, application of the gate voltage is performed while the inside of the liquid crystal layer is in a state in which a voltage is not applied thereto, and thus high response characteristics can be obtained.

The liquid crystal molecules 5 in the n−x^{th} to n−1^{th} rows to which the voltage V2 is applied align in a direction that is orthogonal to the long axis of the comb-shaped electrode pair. Hence, light that passes through the liquid crystal layer 4 in this state is transformed to polarized light having an axis in a direction that is orthogonal to the transmission axis of the polarizer (second polarizer) 2 on the opposed substrate 60 side. As a result, the light is blocked by the second polarizer and the display enters an “off” (black display) state.

The response to enter a black display state in this case is performed by means of an alignment change in which a high voltage is applied to liquid crystal molecules that were originally aligned in a direction at an angle of 45 degrees relative to the direction of the transmission axis of the polarizer to thereby cause the liquid crystal molecules to rotate in the horizontal or vertical direction relative to the direction of the transmission axis of the polarizer. The aforementioned response compares favorably with a response performed in the conventional manner by means of an alignment change that causes liquid crystal molecules that were originally aligned in a horizontal direction relative to a substrate surface to fall in the vertical direction. Further, since a response from a black display state to a gradation display state uses fall characteristics that cause liquid crystal molecules that were aligned in the direction of the transmission axis of the polarizer by means of a high electric field to rotate while applying a lower voltage thereto, response characteristics of a change to a gradation display state are improved.

In this connection, according to Embodiment 3, the gate voltage V2 of the gate wiring of the TFT substrate 50 is used as a voltage that is applied to the opposed pixel electrode 23, and the voltage is a sufficient size with respect to the source voltage V1 that is applied to the TFT pixel electrode.

As shown in FIG. 26 and FIG. 28, the gate wiring of the nth row to, and 1^{st} row to the n−x−1^{th} row is connected to the TFT pixel electrode 21, and thus the voltage V1 is applied into the liquid crystal layer, by the TFT comb-shaped electrode pair.

The liquid crystal molecules 5 of the n^{th} row to, and 1^{st} row to the n−x−1^{th} row to which the voltage V1 is applied exhibit an alignment along an arch-shaped transverse electric field formed between the TFT comb-shaped electrode pair. More specifically, since the liquid crystal molecules 5 align in a direction that is orthogonal to the long axis of the comb-shaped electrode pair, light that passes through the liquid crystal layer in this state is polarized to polarized light having an axis in a direction that is orthogonal to the transmission axis of the polarizer (first polarizer) 1 on the TFT substrate 50 side. As a result, light that has passed through the liquid crystal layer 4 is transmitted through the second polarizer 2 and the display enters an “on” (gradation display) state.

The behavior of liquid crystal molecules in the liquid crystal layer as well as changes in the polarizing state of light in the liquid crystal display device of Embodiment 3 described above will now be described in further detail for the respective timings.

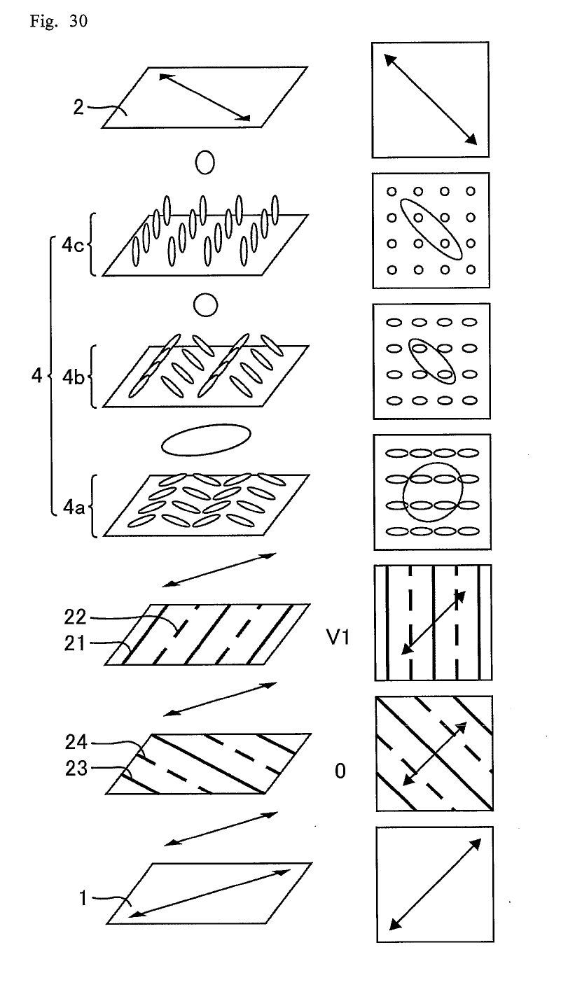

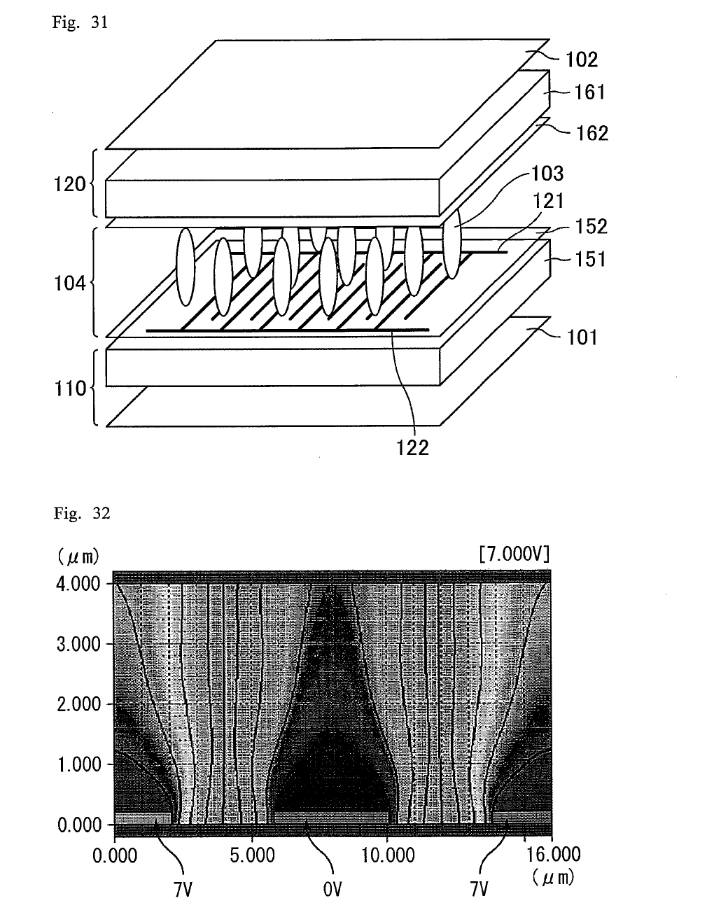

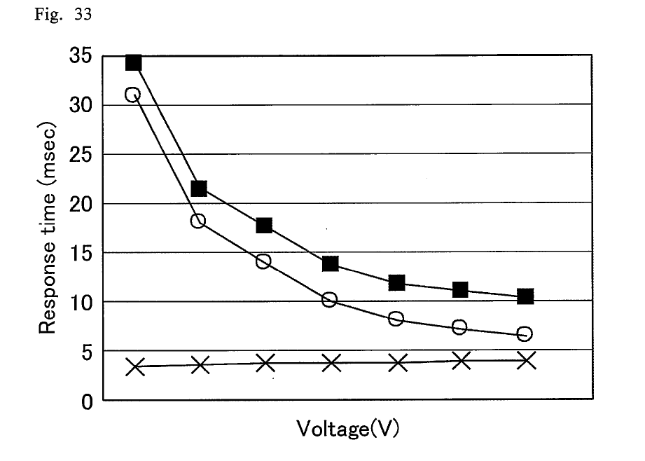

FIG. 29 and FIG. 30 are schematic diagrams illustrating the configuration of each member of the liquid crystal display device of Embodiment 3 while light passes through the respective members, as well as respective stages showing the polarizing state of the transmitted light. FIG. 29 illustrates a state at a time of a black display, and FIG. 30 illustrates a state at a time of a gradation display. The left columns in FIG. 29 and FIG. 30 represent perspective views, and the right columns represent plan views when a display region is viewed from a normal line direction. The respective views show constituent members of the liquid crystal display device at respective stages, and the respective double-headed arrows show the vibration direction of light at the respective stages.

First, with respect to FIG. 29, the order in which light is transmitted is described from the bottom side, that is, from the incidence side of light from the backlight. FIG. 29 shows a state in which a voltage of V2 is applied into the liquid crystal layer by means of the opposed comb-shaped electrode pair of the TFT substrate.

When light from the backlight is incident within the liquid crystal display panel, first, only light in the transmission axis direction of the polarizer is transmitted by the polarizer (first polarizer) 1 on the TFT substrate side.

Subsequently, the light passes through the opposed comb-shaped electrodes 23 and 24, the TFT comb-shaped electrodes 21 and 22, and liquid crystal molecules (lower layer liquid crystals) 4a that are adjacent to the TFT substrate. At this time, the lower layer liquid crystals 4a receive the influence of the voltage V2 generated by the opposed comb-shaped electrodes 23 and 24, and tilt in a diagonal direction relative to the substrate surface. However, the orientation of the long axis of the liquid crystal molecule when viewed from a normal line direction relative to the substrate surface is orthogonal to the orientation of the long axis of the comb tooth portion of the opposed comb-shaped electrodes 23 and 24, that is, is a parallel direction to the vibration direction of the light. Therefore, light that is transmitted through the lower layer liquid crystal 4a does not receive the influence of birefringence of the liquid crystal molecules, and passes through while retaining the same vibration direction.

Next, the light passes through the liquid crystal molecules (center liquid crystals) 4b that are positioned in the central region of the liquid crystal layer. Although the size of the tilt of the center liquid crystals 4b is different to that of the lower layer liquid crystals 4a, because the center liquid crystals 4b receive the influence of the voltage V2 that is generated by the opposed comb-shaped electrodes 23 and 24, the tendency is the same as for the lower layer liquid crystals 4a, and the orientation of the long axis of the liquid crystal molecule when viewed from a normal line direction relative to the substrate surface is a parallel direction to the vibration direction of the light. Consequently, light that is transmitted through the center liquid crystals 4b does not receive the influence of birefringence of the liquid crystal molecules and passes through while retaining the same vibration direction.

Subsequently, the light passes through the liquid crystal molecules (upper layer liquid crystals) 4c that are adjacent to the opposed substrate. Since the upper layer liquid crystals 4c do not receive the influence of the electric field and vertical alignment of the upper layer liquid crystals 4c is maintained, the light passes through in a state in which the vibration direction of the light remains in the same direction.

Next, the light arrives at the polarizer (second polarizer) 2 on the opposed substrate side. Since the direction of the transmission axis of the second polarizer 2 is orthogonal to the direction of vibration of the light that has passed through the liquid crystal layer 4, the light is blocked by the second polarizer 2.

Thus, in a state in which a voltage is being applied into the liquid crystal layer by means of the opposed substrate side 23 and 24, the display is a black display (an off state).

Next, with respect to FIG. 30, the order in which light is transmitted is described from the bottom side, that is, from the incidence side of light from the backlight. FIG. 30 shows a state in which a voltage of V1 is applied into the liquid crystal layer by means of the TFT comb-shaped electrodes 21 and 22.

When light from the backlight is incident within the liquid crystal display panel, first, only light in the transmission axis direction of the polarizer is transmitted by the polarizer (first polarizer) 1 on the TFT substrate side.

Next, the light passes through the opposed comb-shaped electrodes 23 and 24, the TFT comb-shaped electrodes 21 and 22, and the lower layer liquid crystals 4a. At this time, since the voltage V1 is being applied into the liquid crystal layer 4 by the TFT comb-shaped electrodes 21 and 22, the lower layer liquid crystals 4a tilt in a diagonal direction relative to the substrate surface, and the orientation of the long axis of the lower layer liquid crystal 4a when the substrate surface is viewed from a normal line direction is orthogonal to the long axis direction of the comb tooth portion of the TFT comb-shaped electrodes 21 and 22. That is, the long axis direction of the liquid crystal molecule when the substrate surface is viewed from the normal line direction and the vibration direction of the light form an angle of substantially 45°, and light that passes through the lower layer liquid crystal 4a forms elliptically polarized light having a long axis in a direction that forms an angle of substantially 45° with the long axis direction of the liquid crystal molecule when the substrate surface is viewed from the normal line direction.

Subsequently, the light passes through the center liquid crystals 4b. At this time, since the center liquid crystals 4b also receive the influence of the voltage V1 that is generated by the TFT comb-shaped electrodes 21 and 22, the orientation of the long axis of the liquid crystal molecule when viewed from a normal line direction with respect to the substrate surface is orthogonal to the long axis direction of the comb tooth portion of the TFT comb-shaped electrodes 21 and 22. However, since the tilt angle of the center liquid crystals 4b with respect to the substrate surface is greater than the tilt angle of the lower layer liquid crystals 4a with respect to the substrate surface, light that is transmitted through the center liquid crystals 4b is converted to elliptically polarized light in which the direction of the long axis is rotated by 90°.

Next, the light passes through the upper layer liquid crystals 4c. Since the upper layer liquid crystals 4c do not receive the influence of the electric field and are maintained in a state of vertical alignment, light that passes through the upper layer liquid crystals 4c is converted from elliptically polarized light to substantially linearly polarized light while retaining the long axis orientation of the light as it is. More specifically, the light is converted to light having a vibration direction in a direction that forms an angle of 90° with respect to the vibration direction of the light when the light was incident.

Subsequently, the light arrives at the polarizer (second polarizer) 2 on the opposed substrate side. Since the direction of the transmission axis of the second polarizer 2 is parallel to the direction of vibration of light that has passed through the liquid crystal layer 4, the light can pass through the second polarizer 2.

Thus, in a state in which a voltage is being applied into the liquid crystal layer by the comb-shaped electrodes 21 and 22 on the TFT substrate side, the display is a gradation display (in an “on” state), and a transmittance that is in accordance with the voltage can be obtained.

According to the liquid crystal display device of Embodiment 3, switching between off and on states is performed in this manner at separate timings and with separate pairs of comb-shaped electrodes. Further, for all gradation displays, a black display is obtained with a fast response by a rise effect that is caused by the large voltage V2 that is applied to the opposed comb-shaped electrode pair when selecting the previous row (n−x^{th} row), and a gradation display is obtained with a fast response by a fall effect that is caused by the voltage V1 that is applied to the TFT comb-shaped electrode pair when selecting the relevant row (n^{th} row to, and 1^{st} row to an n−x^{th} row). Hence, dramatically improved response characteristics can be obtained for the overall display device.

The behavior of the liquid crystal molecules according to Embodiment 3 as illustrated in FIG. 29 and FIG. 30 is similar to the behavior of the liquid crystal molecules according to Embodiments 1 and 2 as illustrated in FIG. 13 and FIG. 14, and even in a case where the opposed comb-shaped electrode pair are disposed on the TFT substrate side in Embodiment 3, as long as a voltage of V2 is applied into the liquid crystal layer by the opposed comb-shaped electrode pair, a similar effect as that of Embodiment 1 can be obtained, and a graph that is the same as the graph of response characteristics shown in FIG. 15 can be obtained.

Note that, in the liquid crystal display device of Embodiment 3, even in a case where light is incident from the opposite direction to that described above, the light will exhibit similar changes, and hence the tendency for light to be transmitted or blocked by a polarizer will not change. Accordingly, in Embodiment 3, as long as the arrangement relationship between each comb-shaped electrode pair and each polarizer does not change, the incident direction of light may be from the opposed substrate side. In addition, in the liquid crystal display device of Embodiment 3, the first comb-shaped electrode pair and the second comb-shaped electrode pair may also be disposed on the opposed substrate side. Further, the voltage V2 that is applied to the opposed comb-shaped electrode pair need not necessarily be a voltage that is applied through the gate wiring.

Although either of the TFT comb-shaped electrode pair and the opposed comb-shaped electrode pair may be disposed nearer to the liquid crystal layer side, when a large voltage that is greater than or equal to the maximum driving voltage can be applied to the opposed comb-shaped electrode pair, it is preferable to dispose the TFT comb-shaped electrode pair nearer to the liquid crystal layer side than the opposed comb-shaped electrode pair. As a result a voltage can be applied more efficiently into the liquid crystal layer.

By further disposing a transparent electrode over the entire area on the opposed substrate side on which a comb-shaped electrode pair is not formed, it is possible to prevent charge-up from outside the cell, and the display can be stabilized.

The present application claims priority to Patent Application No. 2009-184818 filed in Japan on Aug. 7, 2009 under the Paris Convention and provisions of national law in a designated State, the entire contents of which are hereby incorporated by reference.

### EXPLANATION OF SYMBOLS

1: First polarizer (TFT substrate side)
2: Second polarizer (opposed substrate side)
4: Liquid crystal layer
4a: Lower layer liquid crystals
4b: Center liquid crystals
4c: Upper layer liquid crystals
5: Liquid crystal molecules
11: Source wiring (signal wiring)
12, 12a, 12b: Gate wiring (scanning wiring)
13: Cs wiring (storage capacitor wiring)
21: TFT pixel electrode, TFT comb-shaped electrode, first comb-shaped electrode
22: TFT common electrode, TFT comb-shaped electrode, first comb-shaped electrode
23: Opposed pixel electrode, opposed comb-shaped electrode, second comb-shaped electrode
24: Opposed common electrode, opposed comb-shaped electrode, second comb-shaped electrode
31: Source electrode
32: Gate electrode
33: Drain electrode, Cs electrode
35: Semiconductor layer
36: Reset electrode
37: Gate pad portion
38: Cs pad portion
41: First contact portion
42: Second contact portion
43: Third contact portion
44: Fourth contact portion
45: Fifth contact portion
50: TFT substrate
51: Transparent substrate (TFT substrate side)
52: Vertical alignment layer (TFT substrate side)
53: Insulator
60: Opposed substrate
61: Transparent substrate (opposed substrate side)
62: Vertical alignment layer (opposed substrate side)
71: First TFT (thin film transistor)
72: Second TFT (thin film transistor)
73: Third TFT (thin film transistor)
74: Fourth TFT (thin film transistor)
75: Fifth TFT (thin film transistor)
81: Opposed Cs electrode
82: Opposed Cs wiring
101, 102: Polarizer
103: Liquid crystal molecules
104: Liquid crystal layer
110, 120: Substrate
121, 122: Comb-shaped electrode pair
151, 161: Transparent substrate
152, 162: Vertical alignment layer

1. A liquid crystal display device comprising a pair of substrates that are disposed facing each other, and a liquid crystal layer that is sandwiched between the pair of substrates, wherein:
the liquid crystal layer contains liquid crystal molecules having positive dielectric anisotropy;
the liquid crystal molecules align in a vertical direction relative to surfaces of the pair of substrates in a state in which a voltage is not applied thereto;
the pair of substrates includes two or more sets of comb-shaped electrode pairs in which comb tooth portions of each comb-shaped electrode are alternately disposed with each other with a certain space therebetween;
one substrate of the pair of substrates comprises a first polarizer;
another substrate of the pair of substrates comprises a second polarizer;
a long axis of a comb tooth portion of a first comb-shaped electrode pair among the two or more sets of comb-shaped electrode pairs and a transmission axis of the first polarizer form an angle of substantially 45°;
a long axis of a comb tooth portion of a second comb-shaped electrode pair among the two or more sets of comb-shaped electrode pairs and a transmission axis of the second polarizer are in a parallel or orthogonal relationship with each other;
the transmission axis of the first polarizer and the transmission axis of the second polarizer are orthogonal to each other; and
the first comb-shaped electrode pair and the second comb-shaped electrode pair overlap with each other when the surfaces of the pair of substrates are viewed from a normal line direction.

2. The liquid crystal display device according to claim 1, wherein:
the first and second comb-shaped electrode pairs are disposed on respectively different substrates among the pair of substrates.

3. The liquid crystal display device according to claim 1, wherein:
the first and second comb-shaped electrode pairs are disposed on the same substrate among the pair of substrates.

4. The liquid crystal display device according to claim 1, wherein:
one comb-shaped electrode of the first comb-shaped electrode pair is a pixel electrode that supplies a signal voltage; and
another comb-shaped electrode of the first comb-shaped electrode pair is a common electrode that supplies a common voltage.

5. The liquid crystal display device according to claim 4, wherein:
a signal voltage that is supplied by a pixel electrode of the second comb-shaped electrode pair is greater than a signal voltage that is supplied by the pixel electrode of the first comb-shaped electrode pair.

6. The liquid crystal display device according to claim 1, wherein:
a space between each comb tooth portion of the second comb-shaped electrode pair is smaller than a space between each comb tooth portion of the first comb-shaped electrode pair.

7. The liquid crystal display device according to claim 4, wherein:
a substrate comprising the first comb-shaped electrode pair has a plurality of rows of scanning signal lines, and thin film transistors thatare connected to each of the plurality of rows of scanning signal lines;
a scanning signal line of a given row among the plurality of rows of scanning signal lines applies a scanning voltage to a thin film transistor that is connected to a scanning signal line of the given row at a timing of supplying a signal voltage to the pixel electrode of the first comb-shaped electrode pair; and
a scanning signal line of a row preceding the given row among the plurality of rows of scanning signal lines applies a scanning voltage to a thin film transistor that is connected to the scanning signal line of the row preceding the given row at a timing of supplying a signal voltage to the pixel electrode of the second comb-shaped electrode pair.

8. The liquid crystal display device according to claim 4, wherein:
a substrate comprising the first comb-shaped electrode pair has a plurality of rows of scanning signal lines, and thin film transistors that are connected to each of the plurality of rows of scanning signal lines;
a scanning signal line of a given row among the plurality of rows of scanning signal lines applies a scanning voltage to a thin film transistor that is connected to a scanning signal line of the given row at a timing of supplying a signal voltage to the pixel electrode of the first comb-shaped electrode pair; and
the pixel electrode of the first comb-shaped electrode pair is connected to a common electrode of the first comb-shaped electrode pair through a resetting thin film transistor that is controlled by a scanning signal line of a row that is next to the given row, or to a storage capacitor wiring that forms a capacitance between the pixel electrode of the first comb-shaped electrode pair and the storage capacitor wiring.
